(19) United States
(12) Patent Application Publication
(10) Pub. No.: US 2025/0153388 A1
(43) Pub. Date: May 15, 2025

(54) Guitar Pickup Cavity Routing Tool Assembly and Method of Use

(71) Applicant: S&S Guitar Works, LLC, Amarillo, TX (US)

(72) Inventors: Matthew Strawn, Amarillo, TX (US); Benjamin Stallwitz, Amarillo, TX (US)

(21) Appl. No.: 18/508,203

(22) Filed: Nov. 13, 2023

(51) Int. Cl. B27C 5/10; G10D 1/08

(52) U.S. Cl. CPC B27C 5/10; G10D 1/085

(57) ABSTRACT

A cavity routing tool assembly for aligning a plurality of plates with one another in a preconfigured manner using a plurality of plugs to cut a multi-tiered pickup cavity into a workpiece. The cavity routing tool assembly comprises two or more plug-plate sets, each comprising a plate and a plug. The plate collectively across all the two or more plug-plate sets are referred to as the plurality of plates, and the plug are referred to as the plurality of plugs. The plurality of plugs are configured to align and guide router cuts to form the multi-tiered pickup cavity in the workpiece. Each among the plurality of plates are configured to selectively align with portions of the plurality of plugs and ensure the multi-tiered pickup cavity is correctly formed in the workpiece.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant, however examples of guitar tools are presented in the information disclosure form.

### BRIEF SUMMARY OF THE INVENTION

A cavity routing tool assembly for aligning a plurality of plates with one another in a preconfigured manner using a plurality of plugs to cut a multi-tiered pickup cavity into a workpiece. Said cavity routing tool assembly comprises two or more plug-plate sets, each comprising a plate and a plug. Said plate collectively across all said two or more plug-plate sets are referred to as said plurality of plates, and said plug are referred to as said plurality of plugs. Said plurality of plugs are configured to align and guide router cuts to form said multi-tiered pickup cavity in said workpiece. Each among said plurality of plates are configured to selectively align with portions of said plurality of plugs and ensure said multi-tiered pickup cavity is correctly formed in said workpiece. Each among said plurality of plates comprises a plate body, and a routing cavity. Each among said plurality of plugs comprises a lower plug portion and an upper plug portion. Said two or more plug-plate sets are referred to using a set integer comprising an identifier for each set, wherein a first plug-plate set comprises a first among said two or more plug-plate sets wherein said set integer equals one, and a last plug plate set comprises a last among said two or more plug-plate sets where said set integer is the highest value within said two or more plug-plate sets. Each among said two or more plug-plate sets are designed in relationship to one another. Regarding said two or more plug-plate sets, a current set and a next set comprise plug plate sets having sequential counts of said set integer. Said two or more plug-plate sets each comprise said plate and said plug. Regarding said current set, said routing cavity of said plate is configured to selectively attach to a portion of said workpiece and align a current cut among said multi-tiered pickup cavity into said workpiece, said plate is configured to be removed from said workpiece, and said upper plug portion of said plug of said current set is configured to align and fit into said current cut. Regarding the interaction of said current set with said next set, said lower plug portion of said plug in said current set is configured to align with and fit within said routing cavity of said plate of said next set. Said two or more plug-plate sets are configured in the relationships described as said current set and said next set from said first plug-plate set to said last plug plate set. Said current cut for said first plug-plate set comprise a cutting location in said workpiece. Said multi-tiered pickup cavity comprises the sum of each said current cut in said workpiece for each among said plurality of plates in said two or more plug-plate sets. Said two or more plug-plate sets are configured to align each said routing cavity among said plurality of plates using said plurality of plugs. One or more alignment markings are displayed in an exterior surface of said plurality of plates. Said upper plug portion of said plurality of plugs are smaller than said lower plug portion of said plurality of plugs. Said set integer for said last plug plate set comprises three. Said two or more plug-plate sets comprises said first plug-plate set, a second plug-plate set and a third plug-plate set. Said third plug-plate set comprises said last plug plate set.

Said cavity routing tool assembly for aligning said plurality of plates with one another in a preconfigured manner using said plurality of plugs to cut said multi-tiered pickup cavity into said workpiece. Said cavity routing tool assembly comprises said two or more plug-plate sets, each comprising said plate and said plug. Said plate collectively across all said two or more plug-plate sets are referred to as said plurality of plates, and said plug are referred to as said plurality of plugs. Said plurality of plugs are configured to align and guide router cuts to form said multi-tiered pickup cavity in said workpiece. Each among said plurality of plates are configured to selectively align with portions of said plurality of plugs and ensure said multi-tiered pickup cavity is correctly formed in said workpiece. Each among said plurality of plates comprises said plate body, and said routing cavity. Each among said plurality of plugs comprises said lower plug portion and said upper plug portion. Said two or more plug-plate sets are referred to using said set integer comprising an identifier for each set, wherein said first plug-plate set comprises a first among said two or more plug-plate sets wherein said set integer equals one, and said last plug plate set comprises a last among said two or more plug-plate sets where said set integer is the highest value within said two or more plug-plate sets. Each among said two or more plug-plate sets are designed in relationship to one another. Regarding said two or more plug-plate sets, a current set and a next set comprise plug plate sets having sequential counts of said set integer. Said two or more plug-plate sets each comprise said plate and said plug. Regarding said current set, said routing cavity of said plate is configured to selectively attach to a portion of said workpiece and align a current cut among said multi-tiered pickup cavity into said workpiece, said plate is configured to be removed from said workpiece, and said upper plug portion of said plug of said current set is configured to align and fit into said current cut. Regarding the interaction of said current set with said next set, said lower plug portion of said plug in said current set is configured to align with and fit within said routing cavity of said plate of said next set. Said two or more plug-plate sets are configured in the relationships described as said current set and said next set from said first plug-plate set to said last plug plate set. Said current cut for said first plug-plate set comprise said cutting location in said workpiece. Said multi-tiered pickup cavity comprises the sum of each said current cut in said workpiece for each among said plurality of plates in said two or more plug-plate sets. Said two or more plug-plate sets are configured to align each said routing cavity among said plurality of plates using said plurality of plugs.

Said cavity routing tool assembly for aligning said plurality of plates with one another in a preconfigured manner using said plurality of plugs to cut said multi-tiered pickup cavity into said workpiece. Said cavity routing tool assembly comprises an index system and said two or more plug-plate sets. Said cavity routing tool assembly comprises said two or more plug-plate sets, each comprising said plate and said plug. Said plate collectively across all said two or more plug-plate sets are referred to as said plurality of plates, and said plug are referred to as said plurality of plugs. Said plurality of plugs are configured to align and guide router cuts to form said multi-tiered pickup cavity in said workpiece. Each among said plurality of plates are configured to selectively align with portions of said plurality of plugs and ensure said multi-tiered pickup cavity is correctly formed in said workpiece. Each among said plurality of plates comprises said plate body, and said routing cavity. Each among said plurality of plugs comprises said lower plug portion and said upper plug portion. Said index system comprises a top index plate, and an index key assembly having a first index key and a second index key. Said index system and said two or more plug-plate sets selectively interact to align said plurality of plates with one another. Said plate of said first plug-plate set is also referred to as a bottom index plate of said index system. Said index system is configured to align said top index plate with said bottom index plate through a pilot aperture in said workpiece by installing said first index key into said second index key through said pilot aperture, and aligning and securing said routing cavity of said top index plate with a plug portion of said first index key. Regarding an interaction between said index system and said first plug-plate set, said plate of said first plug-plate set is configured to align and secure to said plug portion of said second index key by sliding said routing cavity of said plate around said plug portion of said second index key, having aligned said top index plate with said plate of said first plug-plate set, said index key assembly is configured to be removed from 1800, said routing cavity of said top index plate is configured to guide a top router cut in said workpiece, and said routing cavity of said plate of said first plug-plate set is configured to guide a bottom router cut in said workpiece. Said two or more plug-plate sets are referred to using said set integer comprising an identifier for each set, wherein said first plug-plate set comprises a first among said two or more plug-plate sets wherein said set integer equals one, and said last plug plate set comprises a last among said two or more plug-plate sets where said set integer is the highest value within said two or more plug-plate sets. Each among said two or more plug-plate sets are designed in relationship to one another. Regarding said two or more plug-plate sets, a current set and a next set comprise plug plate sets having sequential counts of said set integer. Said two or more plug-plate sets each comprise said plate and said plug. Regarding said current set, said routing cavity of said plate is configured to selectively attach to a portion of said workpiece and align a current cut among said multi-tiered pickup cavity into said workpiece, said plate is configured to be removed from said workpiece, and said upper plug portion of said plug of said current set is configured to align and fit into said current cut. Regarding the interaction of said current set with said next set, said lower plug portion of said plug in said current set is configured to align with and fit within said routing cavity of said plate of said next set. Said two or more plug-plate sets are configured in the relationships described as said current set and said next set from said first plug-plate set to said last plug plate set. Said current cut for said first plug-plate set comprise said cutting location in said workpiece. Said multi-tiered pickup cavity comprises the sum of each said current cut in said workpiece for each among said plurality of plates in said two or more plug-plate sets. Said two or more plug-plate sets are configured to align each said routing cavity among said plurality of plates using said plurality of plugs.

### BRIEF DESCRIPTION OF THE SEVERAL VIEWS OF THE DRAWING

FIG. 1 illustrates a cavity routing tool assembly 100 in an exploded perspective overview.

FIG. 2 illustrates an elevated top view of a first plate 102a and a first plug 104a arranged beside one another.

FIG. 3 illustrates an elevated top view of a s-style pickup arrangement 300 on a guitar body 108 of a guitar 302.

FIG. 4 illustrates an elevated top view of a p-90 style pickup arrangement 400 on said guitar body 108.

FIG. 5 illustrates an elevated top view of a humbucker style pickup arrangement 500 on said guitar body 108.

FIGS. 6A and 6B illustrate a perspective overview of said guitar body 108 and said first plate 102a, complete and in detail, respectively.

FIG. 7 illustrates a perspective overview of said first plate 102a on a cross-section view of said guitar body 108.

FIG. 8 illustrates a lower perspective view of said first plate 102a on a cross-section view of said guitar body 108.

FIG. 9 illustrates a lower perspective view of said first plate 102a on a cross-section view of said guitar body 108 with a first cut 606.

FIGS. 10A and 10B illustrate a detailed perspective overview of said first plug 104a and a perspective cross-section overview of said first plug 104a installed into said first cut 606 with said guitar body 108.

FIGS. 11A and 11B illustrate a detailed perspective overview of said first plug 104a and a second plate 102b, and a perspective overview of said first plug 104a attached to said second plate 102b and installed in said first cut 606.

FIGS. 12A and 12B illustrate a detailed perspective overview of said second plate 102b, and a perspective overview of said guitar body 108 with a second cut 1200 in a multi-tiered pickup cavity 106.

FIGS. 13A and 13B illustrate a detailed view of a second plug 104b and a perspective overview of said second plug 104b installed into a portion of said second cut 1200.

FIGS. 14A and 14B illustrate a detailed perspective overview of said second plug 104b with a third plate 102c, and a perspective overview of said third plate 102c and said second plug 104b aligned with said second cut 1200.

FIG. 15 illustrates said third plate 102c aligned with said second cut 1200.

FIG. 16 illustrates said third plate 102c aligned with said second cut 1200 and a third cut 1600 in said guitar body 108.

FIGS. 17A, 17B and 17C illustrate a perspective overview of a third plug 104c with a guitar pickup 1700, a negative representation 1702 of said multi-tiered pickup cavity 106, and said third plug 104c and said guitar pickup 1700 installed into said multi-tiered pickup cavity 106.

FIGS. 18A and 18B illustrate an elevated top view and perspective overview of said first plate 102a on a workpiece 1800.

FIG. 19 illustrates a perspective overview of said workpiece 1800 with a non-perpendicular pickup cavity 1900.

FIG. 20 illustrates an exploded perspective overview of said cavity routing tool assembly 100 configured for installation of a bridge pickup 308.

FIGS. 21A and 21B illustrate a perspective lower view of said workpiece 1800 with said first plate 102a and said first cut 606, and said workpiece 1800 with said first plug 104a inserted into a lower end of said first cut 606.

FIGS. 22A and 22B illustrate a perspective overview of said workpiece 1800 with said first plug 104a and said second plate 102b aligned and inserted into a second end 904 of said first cut 606, and said second plate 102b aligned with said second cut 1200.

FIGS. 23A and 23B illustrate a perspective overview of said workpiece 1800 with said first cut 606, said second cut 1200 and said second plate 102b; and said workpiece 1800 with said second plug 104b aligned with said second cut 1200.

FIGS. 24A and 24B illustrate a perspective overview of said workpiece 1800 with said second plug 104b inserted into said second cut 1200, and further said third plate 102c aligned with and attached to said second plug 104b.

FIGS. 25A and 25B illustrate a perspective overview of said workpiece 1800 with said third plug 104c aligned with said second cut 1200, and said workpiece 1800 with said third cut 1600.

FIGS. 26A and 26B illustrate a perspective overview of said workpiece 1800 with said multi-tiered pickup cavity 106 aligned with said third plate 102c and said guitar pickup 1700, and said workpiece 1800 with said guitar pickup 1700 installed into said multi-tiered pickup cavity 106.

FIGS. 27A and 27B illustrate a wireframe perspective lower view and an elevated top wireframe view of said workpiece 1800 with said multi-tiered pickup cavity 106, respectively.

FIGS. 28A and 28B illustrate a cross-section perspective overview of said workpiece 1800 with said first plate 102a, with and without said first cut 606, respectively.

FIGS. 29A and 29B illustrate a cross-section perspective overview of said workpiece 1800 with said first plug 104a in said first cut 606 and said second plate 102b around a portion of said first plug 104a, and said second plate 102b with said second cut 1200.

FIGS. 30A and 30B illustrate a cross-section perspective overview of said workpiece 1800 with said second plug 104b in said second cut 1200, and said third plate 102c around a portion of said second plug 104b.

FIGS. 31A and 31B illustrate a cross-section perspective overview of said workpiece 1800 with said third plate 102c aligned with said third cut 1600, and said third plug 104c in said first cut 606.

FIGS. 32A and 32B illustrate a cross-section perspective overview of said workpiece 1800 with said guitar pickup 1700 and said third plug 104c aligned with and installed in said multi-tiered pickup cavity 106, respectively.

FIGS. 33A and 33B illustrate a perspective overview and an elevated side view in cross-section of said workpiece 1800 with a tilted configuration 3300 of said multi-tiered pickup cavity 106.

FIG. 34 illustrates an exploded perspective overview of said cavity routing tool assembly 100 in said tilted configuration 3300.

FIGS. 35A and 35B illustrate a single key configuration 3500 and a double key configuration 3502 of an index key assembly 3406, respectively.

FIGS. 36A and 36B illustrate first view of said single key configuration 3500 showing a bottom side of a first index key 3406a and a top view of a second index key 3406b and an elevated side view of said single key configuration 3500 assembled.

FIG. 37 illustrates an exploded elevated side view of said cavity routing tool assembly 100 having an index system 3400.

FIGS. 38A and 38B illustrate a perspective overview of said workpiece 1800 having a pilot aperture 3800, viewed without and with said index key assembly 3406, respectively.

FIGS. 39A and 39B illustrate a cross-section elevated side view of said workpiece 1800 with said pilot aperture 3800 and portions of said index system 3400.

FIGS. 40A and 40B illustrate a cross-section perspective overview of said workpiece 1800 having said pilot aperture 3800 with a top index plate 3402 and a bottom index plate 3404 attached to a first side 602 and a second side 604 of said workpiece 1800.

FIGS. 41A and 41B illustrate a cross-section perspective overview and wireframe elevated side view of said workpiece 1800 having said first cut 606 cut through said top index plate 3402.

FIGS. 42A and 42B illustrate a cross-section perspective overview and wireframe elevated side view of said workpiece 1800 having said second cut 1200 cut through said bottom index plate 3404.

FIGS. 43A and 43B illustrate a cross-section perspective overview and wireframe elevated side view of said workpiece 1800 with a portion of said second plug 104b inserted into said second cut 1200.

FIGS. 44A and 44B illustrate a cross-section perspective overview and wireframe elevated side view of said workpiece 1800 with a portion of said second plug 104b inserted into said second cut 1200 and said third plate 102c installed around a portion of said second plug 104b.

FIGS. 45A and 45B illustrate a cross-section perspective overview and wireframe elevated side view of said workpiece 1800 and said third plate 102c, with said third cut 1600 in said workpiece 1800.

FIGS. 46A and 46B illustrate a cross-section perspective overview and wireframe elevated side view of said workpiece 1800, with said third plug 104c and said guitar pickup 1700 installed.

FIG. 47 illustrates an elevated overview of said cavity routing tool assembly 100, presented as two or more plug-plate sets 4700.

FIG. 48 illustrates a cross-section elevated side view of said cavity routing tool assembly 100 with said index system 3400 and said two or more plug-plate sets 4700.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

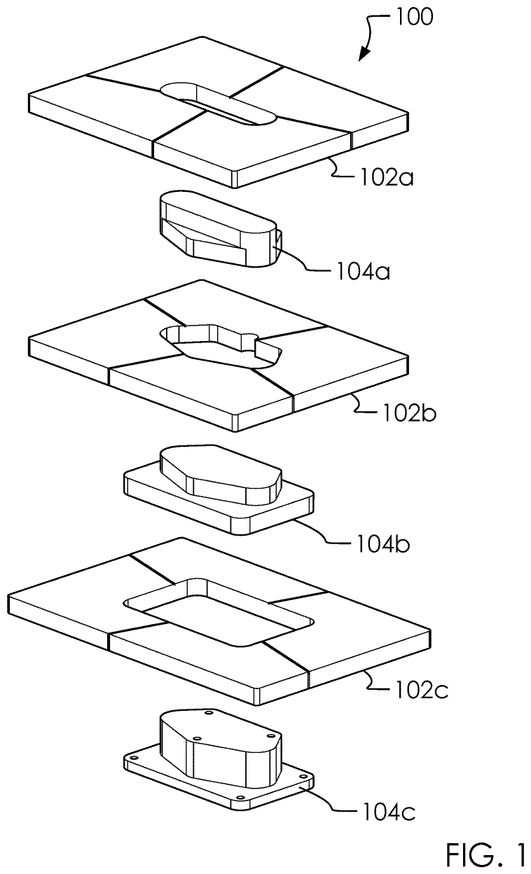

FIG. 1 illustrates a cavity routing tool assembly 100 in an exploded perspective overview.

In one embodiment, said cavity routing tool assembly 100 can comprise a plurality of plates 102 and a plurality of plugs 104 configured to align and cut a multi-tiered pickup cavity 106 (illustrated below) in a guitar body 108 (illustrated below).

Said plurality of plates 102 can comprise a first plate 102a, a second plate 102b and a third plate 102c. Said plurality of plugs 104 can comprise a first plug 104a, a second plug 104b and a third plug 104c.

Each among said plurality of plates 102 can be configured to selectively align with portions of said plurality of plugs 104 and ensure said multi-tiered pickup cavity 106 is correctly formed in said guitar body 108.

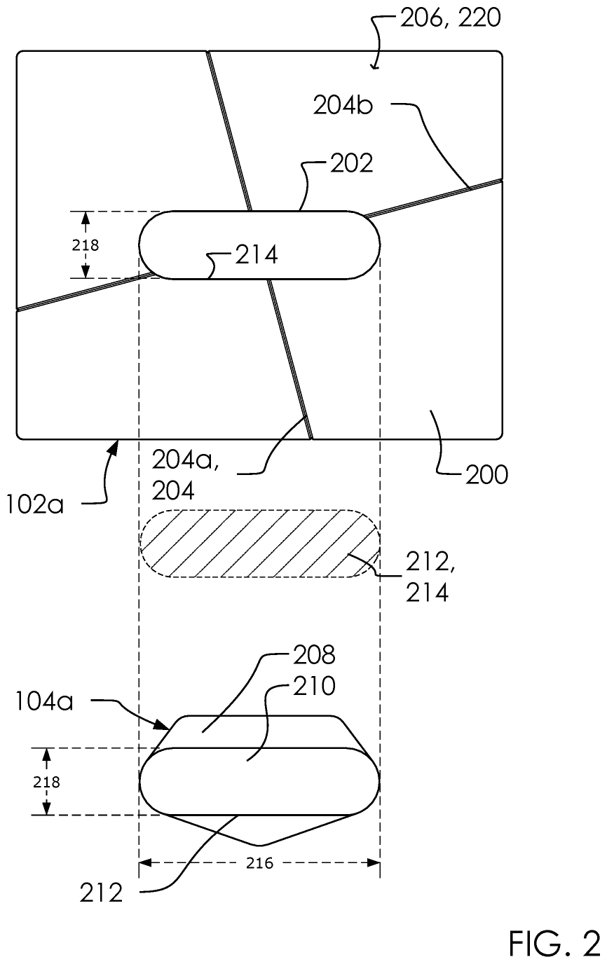

FIG. 2 illustrates an elevated top view of said first plate 102a and said first plug 104a arranged beside one another.

Each among said plurality of plates 102 can comprise a plate body 200, a routing cavity 202, and one or more alignment markings 204. In one embodiment, said one or more alignment markings 204 can comprise a first alignment marking 204a and a second alignment marking 204b being perpendicular to one another. Said one or more alignment markings 204 can be etched into or drawn onto an exterior surface 220, such as a top surface 206, of said plurality of plates 102.

Each among said plurality of plugs 104 can comprise a lower plug portion 208 and an upper plug portion 210. Wherein said lower plug portion 208 is larger than said upper plug portion 210.

In one embodiment, an upper portion horizontal cross-section 212 of said upper plug portion 210 of said first plug 104a can match a router cavity horizontal cross-section 214 of said routing cavity 202 of said first plate 102a. Accordingly, said routing cavity 202 of said first plate 102a can comprise a first width 216 and a first depth 218, which can match those of said upper plug portion 210 of said first plug 104a.

Said cavity routing tool assembly 100 can be configured to align each said routing cavity 202 of said plurality of plates 102 with one another in a preconfigured manner using said plurality of plugs 104 by inserting a portion of said upper plug portion 210 into a portion of said multi-tiered pickup cavity 106, and inserting a portion of said lower plug portion 208 into another among said plurality of plates 102, as discussed herein.

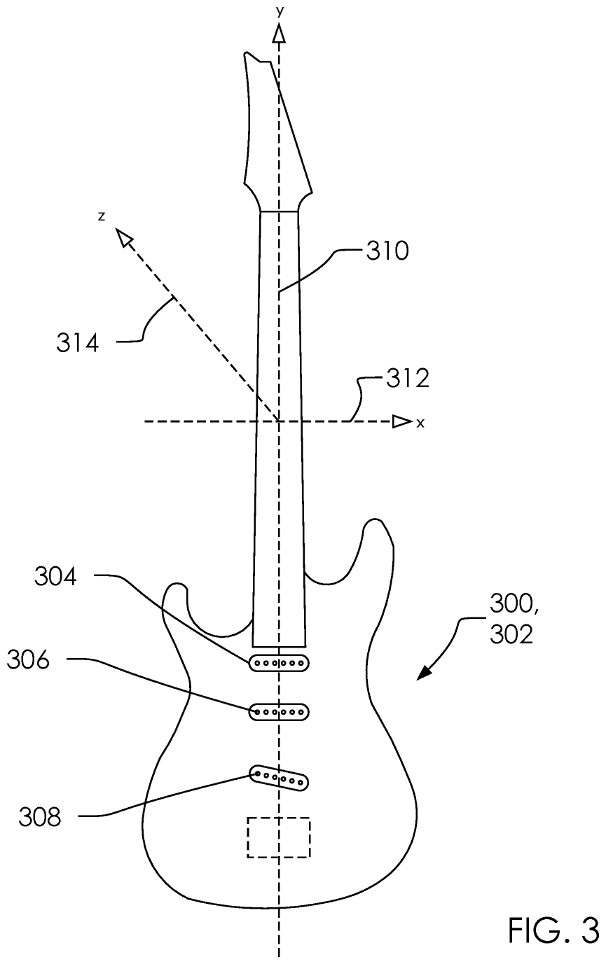

FIG. 3 illustrates an elevated top view of a s-style pickup arrangement 300 on said guitar body 108 of a guitar 302.

Said s-style pickup arrangement 300 can comprise a neck pickup 304, a middle pickup 306 and a bridge pickup 308.

As illustrated, said guitar 302 can comprise an x-axis 310, a y-axis 312 and a z-axis 314. Wherein, said neck pickup 304 and said middle pickup 306 can be arranged perpendicular to said x-axis 310 and substantially aligned with said y-axis 312.

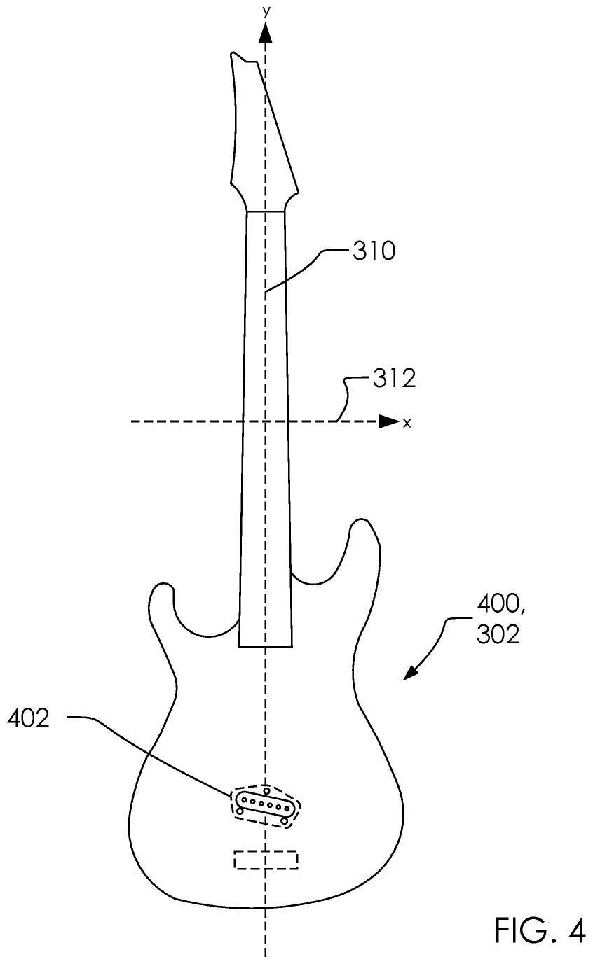

FIG. 4 illustrates an elevated top view of a p-90 style pickup arrangement 400 on said guitar body 108.

In one embodiment, said p-90 style pickup arrangement 400 can comprise a single p-rails pickup 402, as illustrated being substantially rectangular and aligned with said x-axis 310 and said y-axis 312.

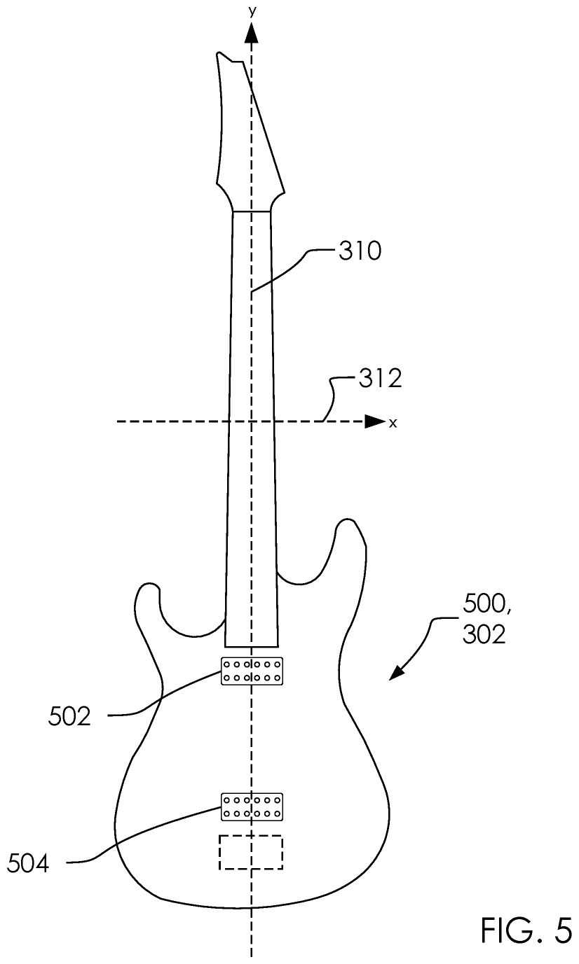

FIG. 5 illustrates an elevated top view of a humbucker style pickup arrangement 500 on said guitar body 108.

In one embodiment, said humbucker style pickup arrangement 500 can comprise a first humbucker pickup 502 and a second humbucker pickup 504. In one embodiment, one among said first humbucker pickup 502 and said second humbucker pickup 504 can be non-aligned in said z-axis 314, as discussed below.

Said humbucker style pickup arrangement 500 can be described as a non-tune-o-matic version of said guitar body 108.

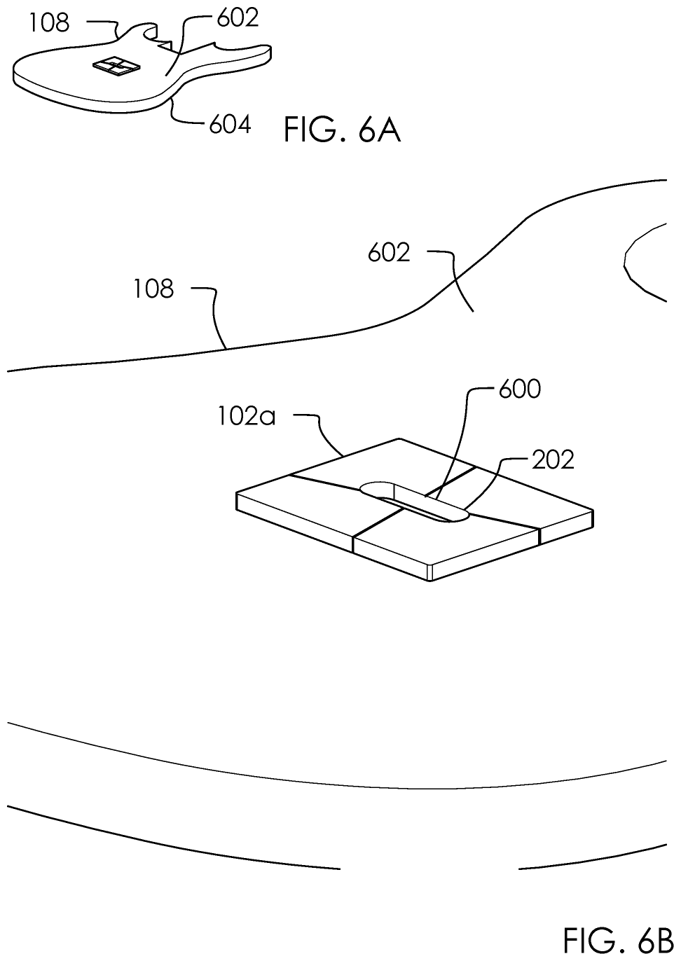

FIGS. 6A and 6B illustrate a perspective overview of said guitar body 108 and said first plate 102a, complete and in detail, respectively.

In one embodiment, said cavity routing tool assembly 100 can be useful for cutting said multi-tiered pickup cavity 106 in said guitar body 108: by aligning said routing cavity 202 of said first plate 102a with a cutting location 600 in a first side 602 of said guitar body 108, routing a first cut 606 into said guitar body 108 from said first side 602 to a second side 604 through said routing cavity 202.

In one embodiment, said plurality of plates 102 can be selectively held on said guitar body 108 using a double-sided tape or adhesive.

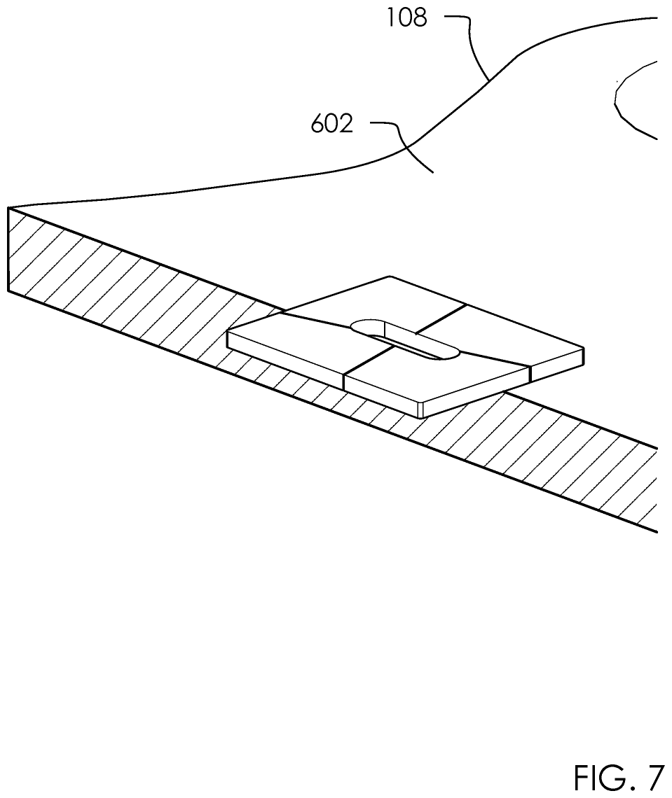

FIG. 7 illustrates a perspective overview of said first plate 102a on a cross-section view of said guitar body 108.

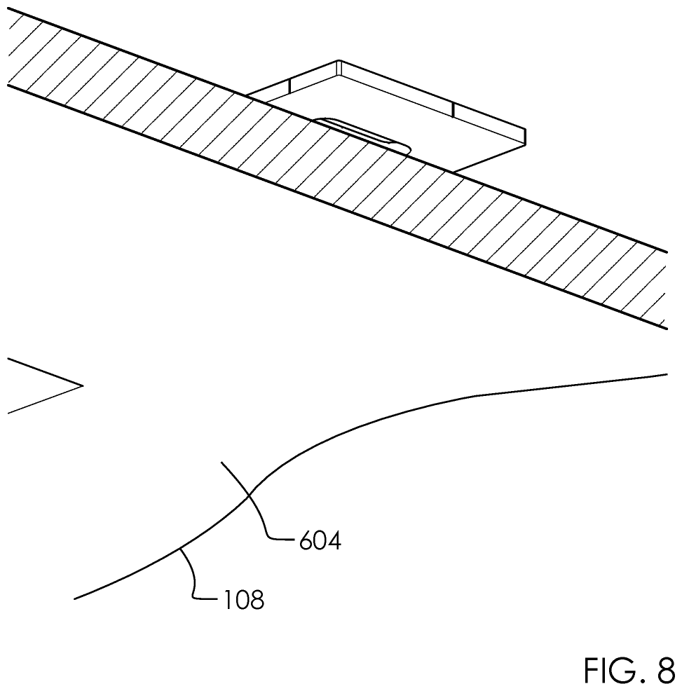

FIG. 8 illustrates a lower perspective view of said first plate 102a on a cross-section view of said guitar body 108.

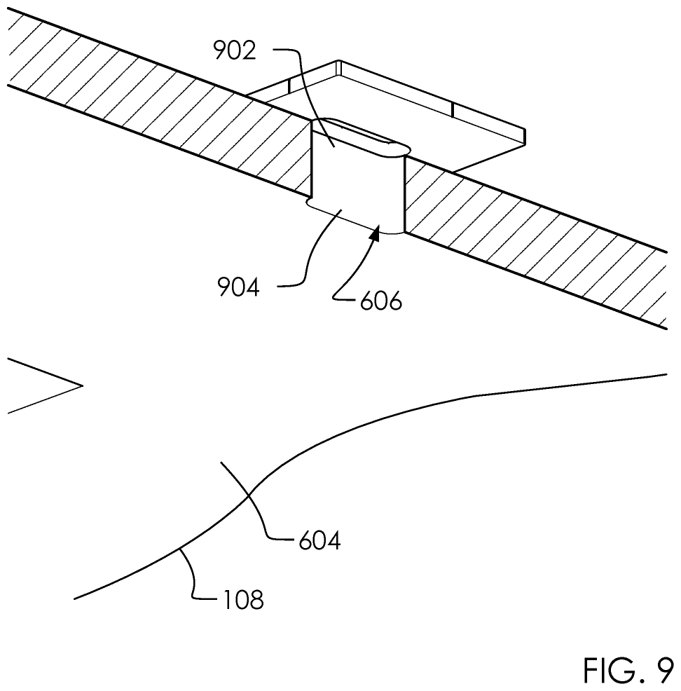

FIG. 9 illustrates a lower perspective view of said first plate 102a on a cross-section view of said guitar body 108 with said first cut 606.

In one embodiment, said first cut 606 can comprise a first end 902 and a second end 904 being associated with said first side 602 and said second side 604 of said guitar body 108, respectively.

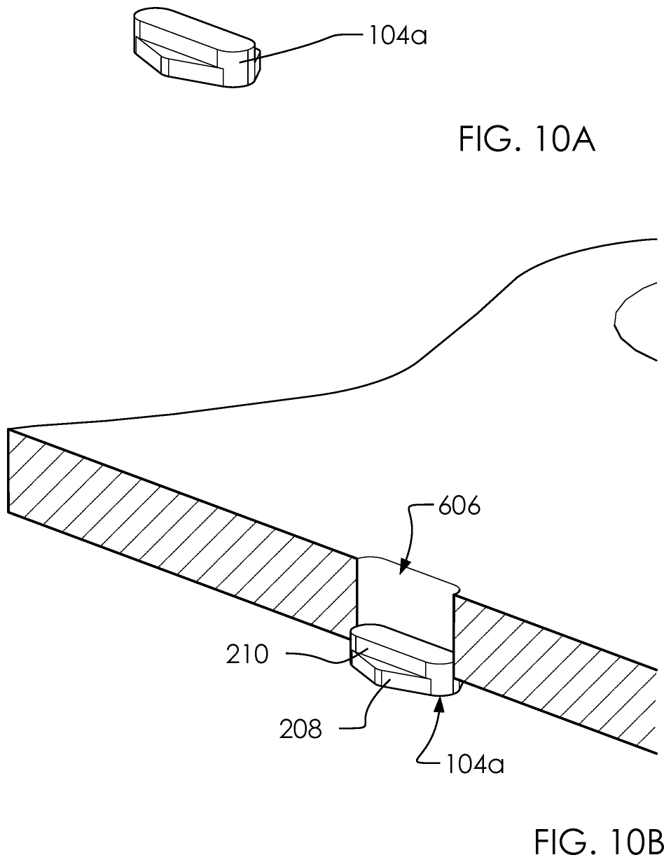

FIGS. 10A and 10B illustrate a detailed perspective overview of said first plug 104a and a perspective cross-section overview of said first plug 104a installed into said first cut 606 with said guitar body 108.

In one embodiment, said first cut 606 can play a part in the alignment of said cavity routing tool assembly 100. For example, said upper plug portion 210 of said first plug 104a can be inserted into said first cut 606; wherein, since said first cut 606 is formed from said routing cavity 202 of said first plate 102a, said upper plug portion 210 can substantially match the shape of said first cut 606 and therefore fit snuggly in said first cut 606. In one embodiment, said upper plug portion 210 can be inserted into said second end 904 of said first cut 606, as illustrated.

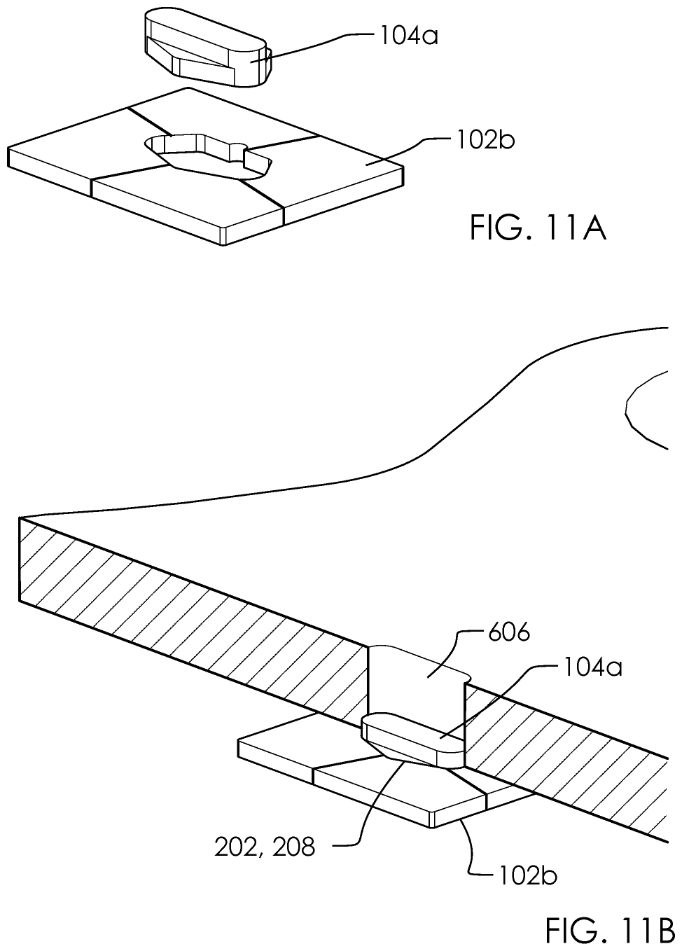

FIGS. 11A and 11B illustrate a detailed perspective overview of said first plug 104a and said second plate 102b, and a perspective overview of said first plug 104a attached to said second plate 102b and installed in said first cut 606.

With said first plug 104a installed in said first cut 606, said lower plug portion 208 can extend outside of said second end 904 of said first cut 606, as illustrated. Further, said lower plug portion 208 can comprise a larger horizontal cross-section than said upper plug portion 210. Wherein, said routing cavity 202 of said second plate 102b can fit around said lower plug portion 208 of said first plug 104a. Thereby, said first plug 104a can be used to align said routing cavity 202 of said second plate 102b with said first cut 606.

Having aligned said second plate 102b with said first plug 104a, an adhesive or double-sided tape can be used to selectively hold said second plate 102b to said second side 604 of said guitar body 108.

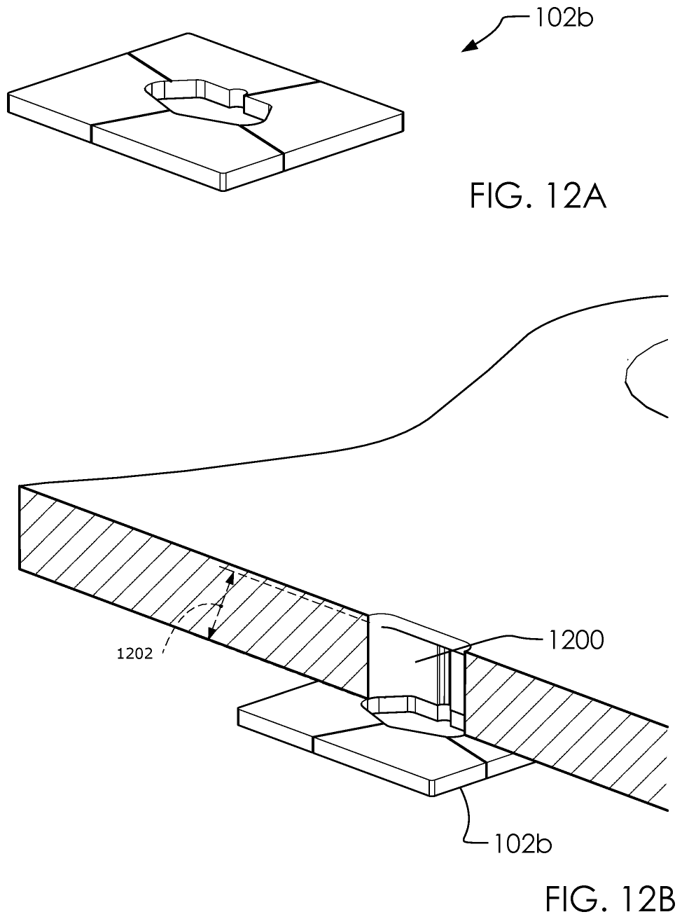

FIGS. 12A and 12B illustrate a detailed perspective overview of said second plate 102b, and a perspective overview of said guitar body 108 with a second cut 1200 in said multi-tiered pickup cavity 106.

In one embodiment, said second plate 102b can be used to create said second cut 1200. By correctly aligning said first plate 102a and said second plate 102b, said second cut 1200 can be properly aligned with said first cut 606. In one embodiment, said second cut 1200 can be cut to a second cut depth 1202, and through a portion of said first cut 606. Said second cut depth 1202 can be less than all the way from said second end 904 to said first end 902.

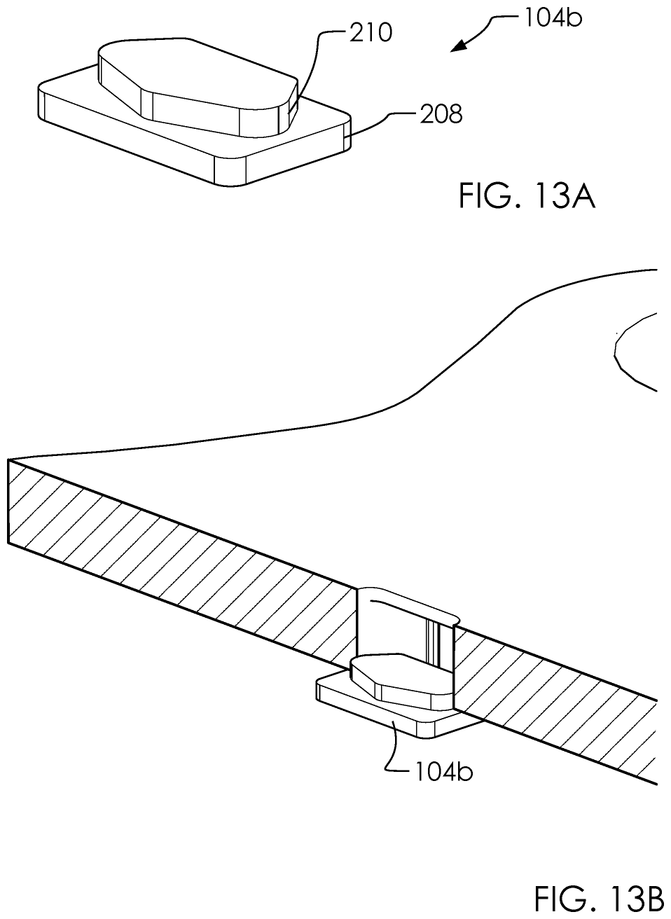

FIGS. 13A and 13B illustrate a detailed view of said second plug 104b and a perspective overview of said second plug 104b installed into a portion of said second cut 1200.

Said second plug 104b can comprise said lower plug portion 208 and said upper plug portion 210, just as with said first plug 104a. In one embodiment, said upper plug portion 210 of said second plug 104b can fit within said second cut 1200, leaving said lower plug portion 208 outside of said second cut 1200.

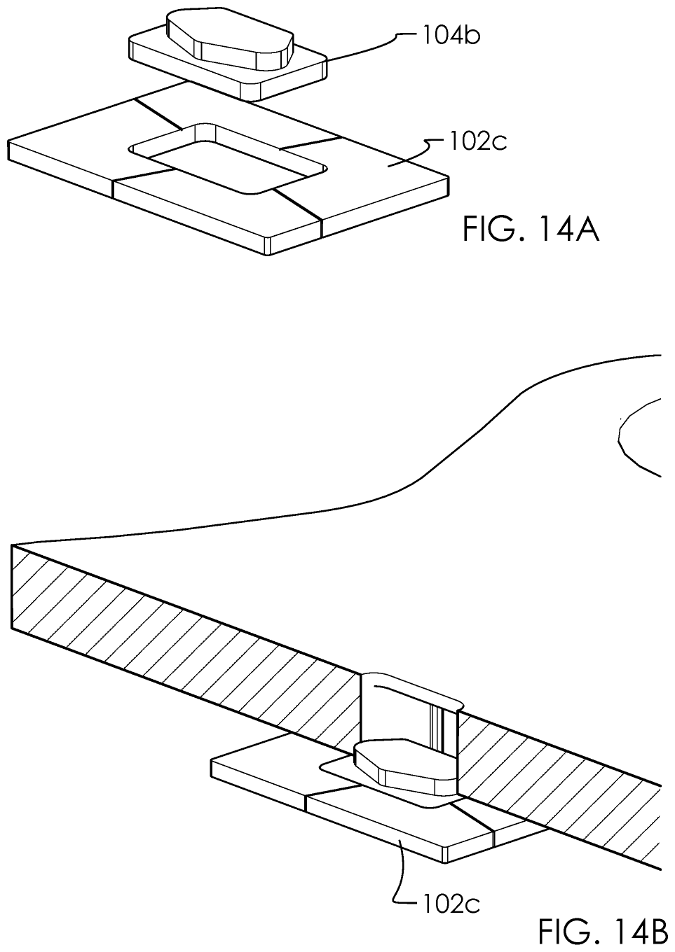

FIGS. 14A and 14B illustrate a detailed perspective overview of said second plug 104b with said third plate 102c, and a perspective overview of said third plate 102c and said second plug 104b aligned with said second cut 1200.

In one embodiment, said lower plug portion 208 of said second plug 104b can fit within said routing cavity 202 of said third plate 102c, as illustrated. Accordingly, said second plug 104b can be used to align said third plate 102c with said second cut 1200.

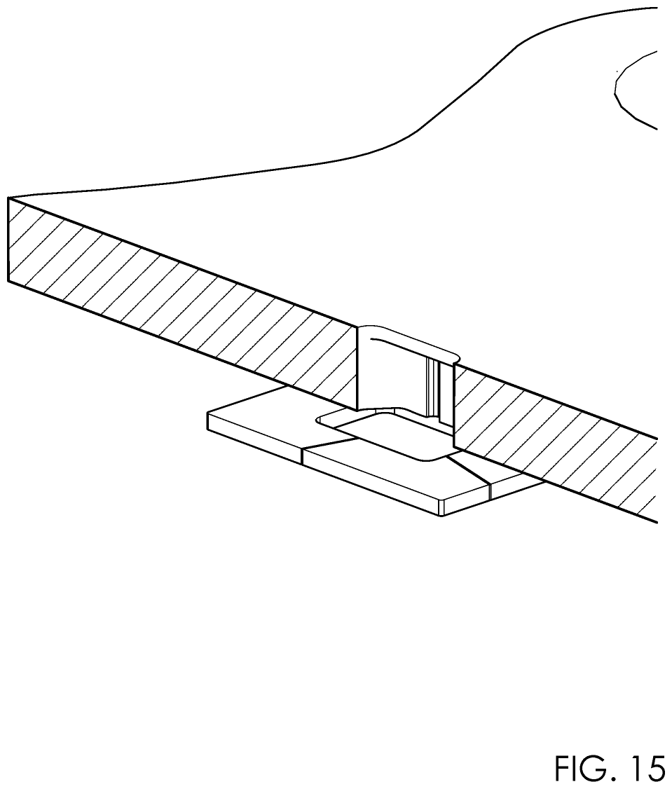

FIG. 15 illustrates said third plate 102c aligned with said second cut 1200.

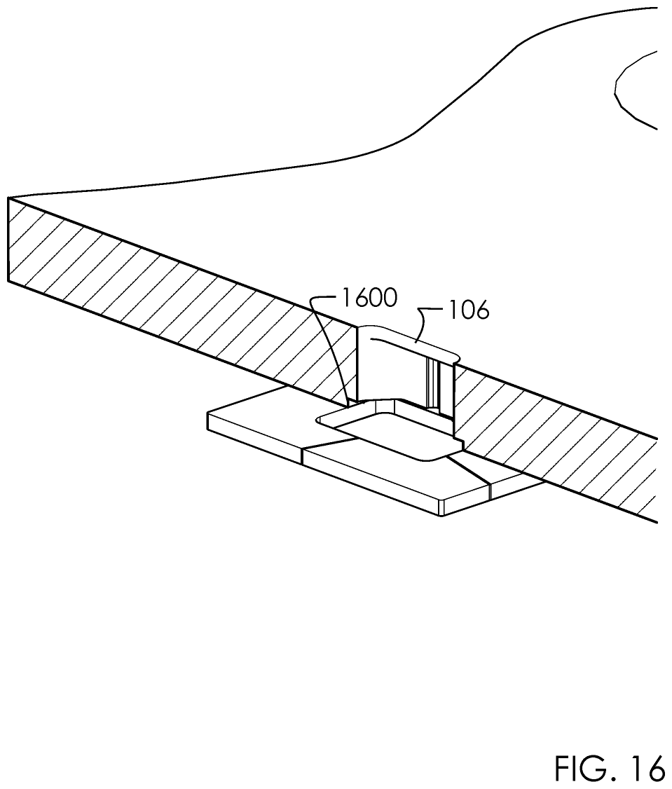

FIG. 16 illustrates said third plate 102c aligned with said second cut 1200 and a third cut 1600 in said guitar body 108.

In one embodiment, the cumulative cavity created by said first cut 606, said second cut 1200 and said third cut 1600 can comprise said multi-tiered pickup cavity 106.

In one embodiment, said third cut 1600 can be routed into a portion of said guitar body 108 through said routing cavity 202 of said third plate 102c.

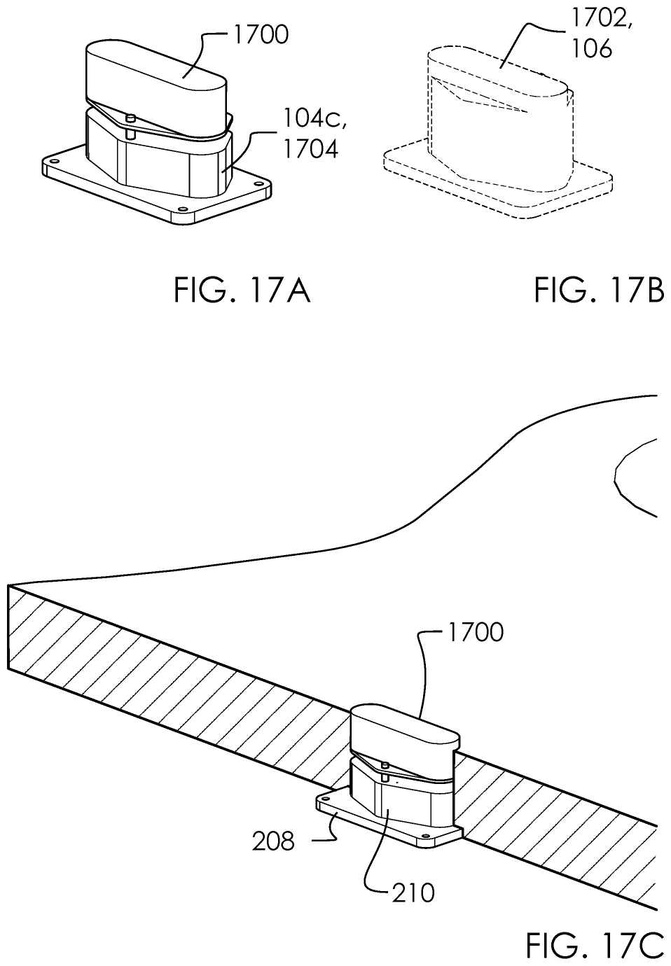

FIGS. 17A, 17B and 17C illustrate a perspective overview of said third plug 104c with a guitar pickup 1700, a negative representation 1702 of said multi-tiered pickup cavity 106, and said third plug 104c and said guitar pickup 1700 installed into said multi-tiered pickup cavity 106.

In one embodiment, said third plug 104c can comprise a mounting bracket 1704 and can be used to install said guitar pickup 1700 into said multi-tiered pickup cavity 106. That is, said third plug 104c and said guitar pickup 1700 can be designed to remain with said guitar body 108 at the completion of cutting said multi-tiered pickup cavity 106 into said guitar body 108.

Examples of said guitar pickup 1700 can comprise said neck pickup 304, said middle pickup 306, said bridge pickup 308, said single p-rails pickup 402, said first humbucker pickup 502 and said second humbucker pickup 504.

In one embodiment, said third cut 1600 can fit a portion of said lower plug portion 208 of said third plug 104c, said second cut 1200 can fit a portion of said upper plug portion 210 of said third plug 104c and said first cut 606 can fit a portion of said guitar pickup 1700.

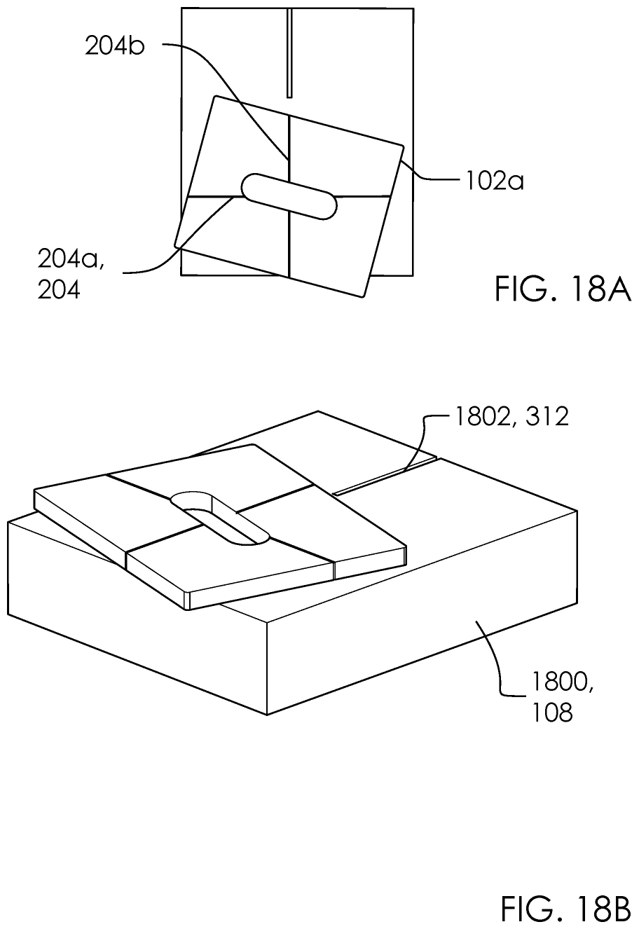

FIGS. 18A and 18B illustrate an elevated top view and perspective overview of said first plate 102a on a workpiece 1800.

For clarity, said workpiece 1800 can comprise an illustrative workpiece comprising an alignment mark 1802. Said workpiece 1800 is a placeholder for said guitar body 108 and this discussion will interchange the terminology of said workpiece 1800 and said guitar body 108.

Said alignment mark 1802 can align with said y-axis 312 and is included for illustration.

In one embodiment, said guitar pickup 1700 can be installed in a non-perpendicular arrangement relative to said y-axis 312. For example, said bridge pickup 308 on said s-style pickup arrangement 300. Wherein, said cavity routing tool assembly 100 can be used to align said guitar pickup 1700 in said non-perpendicular arrangement while maintaining alignment of said third plug 104c relative to said y-axis 312.

In one embodiment, said one or more alignment markings 204 can be used to align said cavity routing tool assembly 100 with said alignment mark 1802. In one embodiment, said second alignment marking 204b can be offset from a perpendicular angle relative to the sides of said first plate 102a. Wherein, one among said one or more alignment markings 204 can align with said y-axis 312 of said guitar body 108 (said alignment mark 1802 of said workpiece 1800, as illustrated). Further wherein, said routing cavity 202 can be non-perpendicular with respect to said y-axis 312.

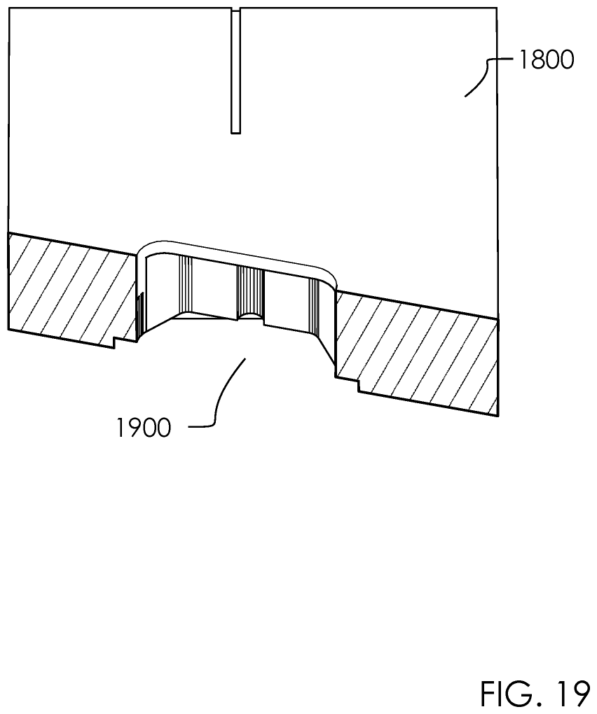

FIG. 19 illustrates a perspective overview of said workpiece 1800 with a non-perpendicular pickup cavity 1900.

In one embodiment, said cavity routing tool assembly 100 can be configured to align and cut said non-perpendicular pickup cavity 1900 into said workpiece 1800 as discussed herein.

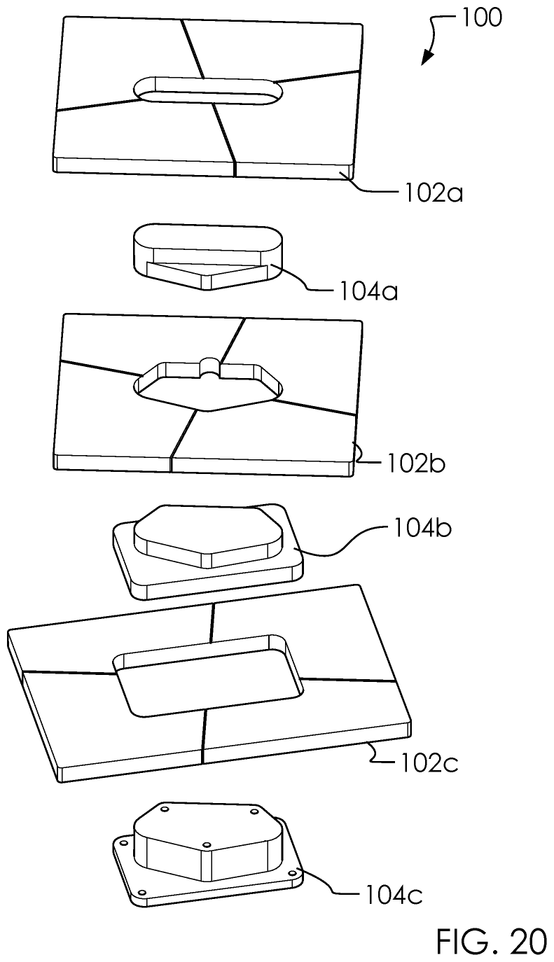

FIG. 20 illustrates an exploded perspective overview of said cavity routing tool assembly 100 configured for installation of said bridge pickup 308.

In one embodiment, said plurality of plates 102 and said plurality of plugs 104 can be aligned at various orientations relative to said x-axis 310, said y-axis 312 and said z-axis 314 to form complex apertures in said workpiece 1800, as discussed and illustrated herein.

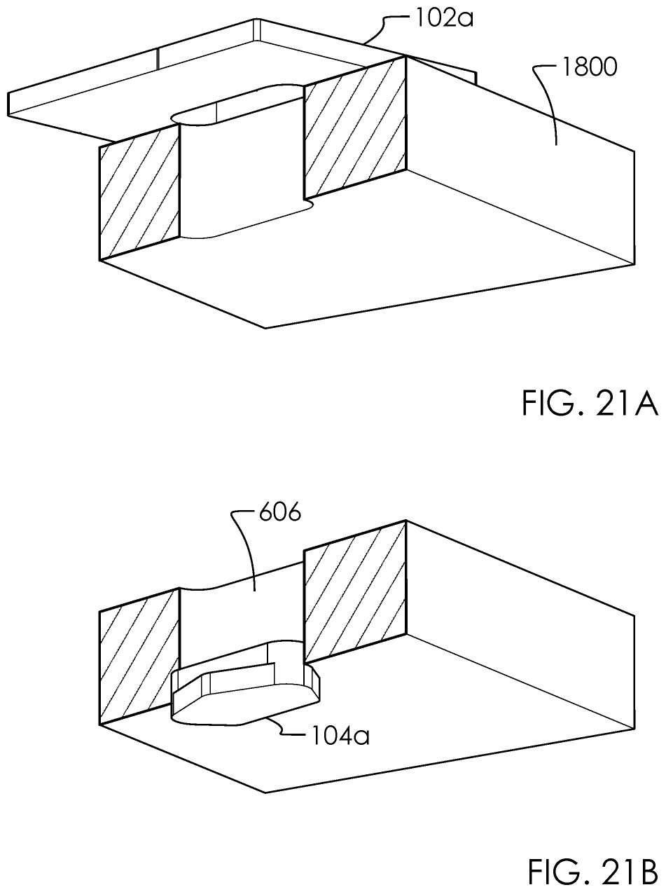

FIGS. 21A and 21B illustrate a perspective lower view of said workpiece 1800 with said first plate 102a and said first cut 606, and said workpiece 1800 with said first plug 104a inserted into a lower end of said first cut 606.

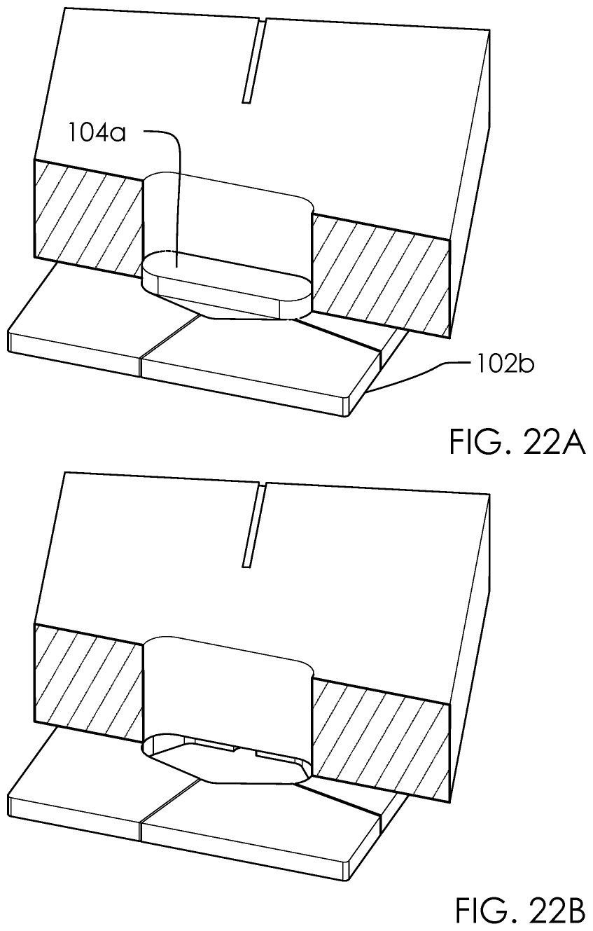

FIGS. 22A and 22B illustrate a perspective overview of said workpiece 1800 with said first plug 104a and said second plate 102b aligned and inserted into said second end 904 of said first cut 606, and said second plate 102b aligned with said second cut 1200.

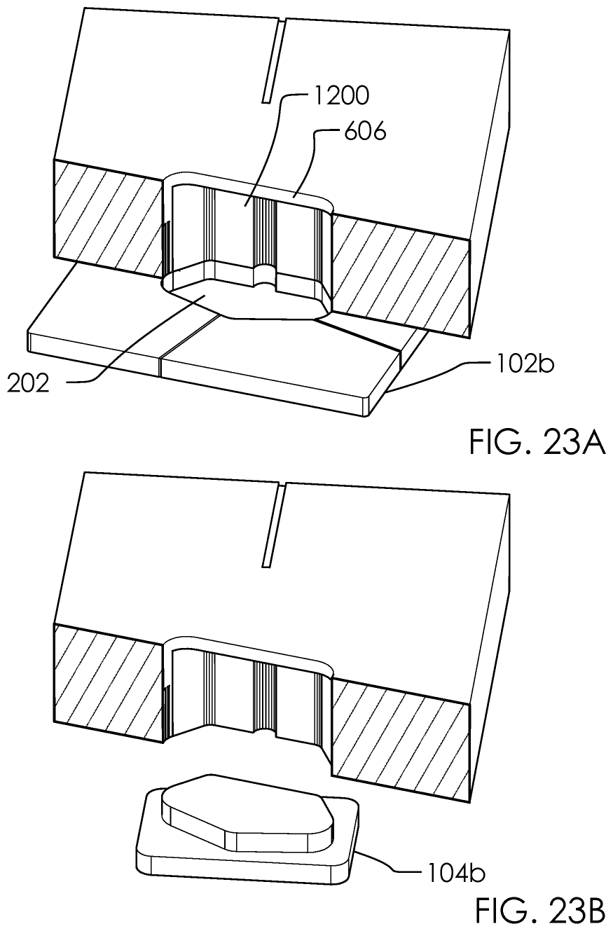

FIGS. 23A and 23B illustrate a perspective overview of said workpiece 1800 with said first cut 606, said second cut 1200 and said second plate 102b; and said workpiece 1800 with said second plug 104b aligned with said second cut 1200.

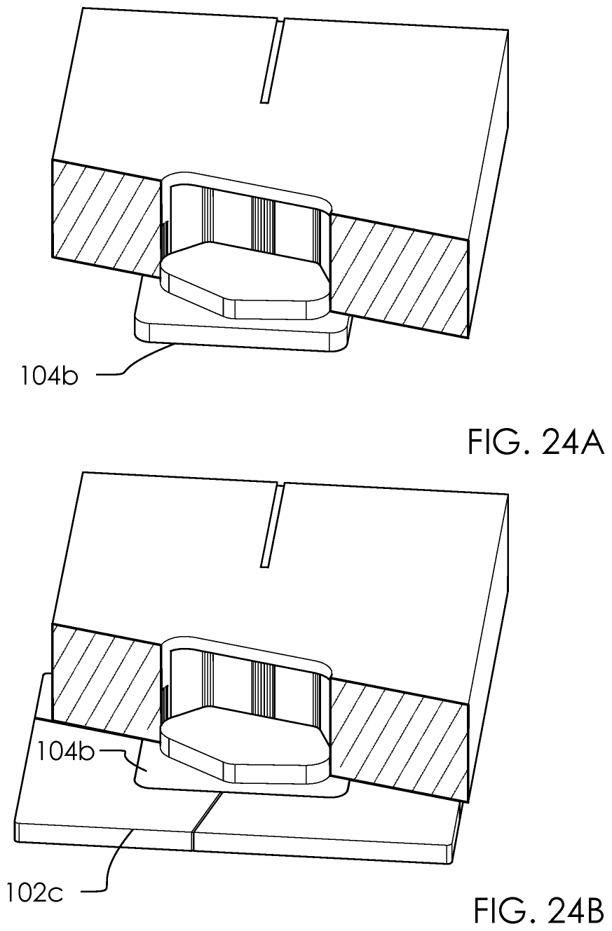

FIGS. 24A and 24B illustrate a perspective overview of said workpiece 1800 with said second plug 104b inserted into said second cut 1200, and further said third plate 102c aligned with and attached to said second plug 104b.

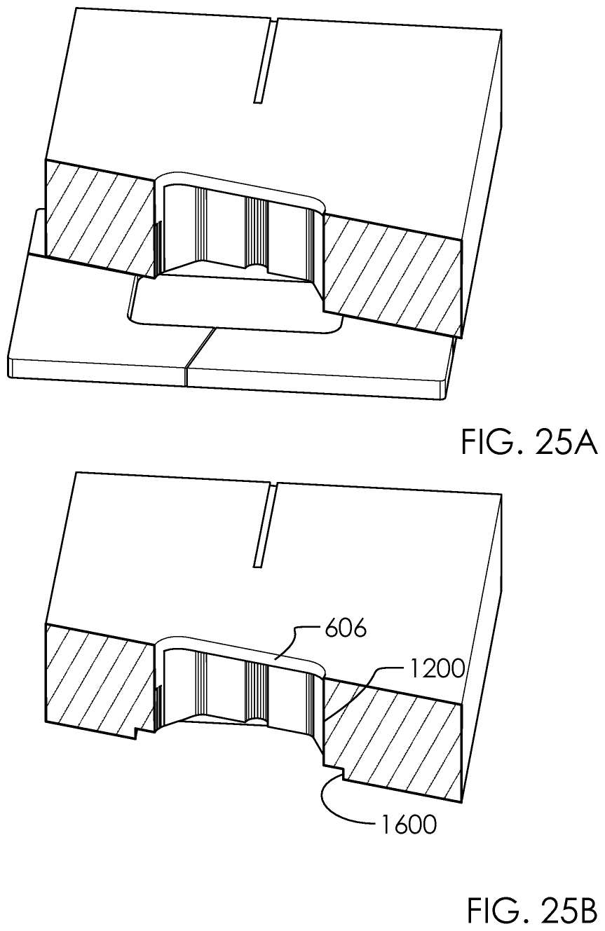

FIGS. 25A and 25B illustrate a perspective overview of said workpiece 1800 with said third plug 104c aligned with said second cut 1200, and said workpiece 1800 with said third cut 1600.

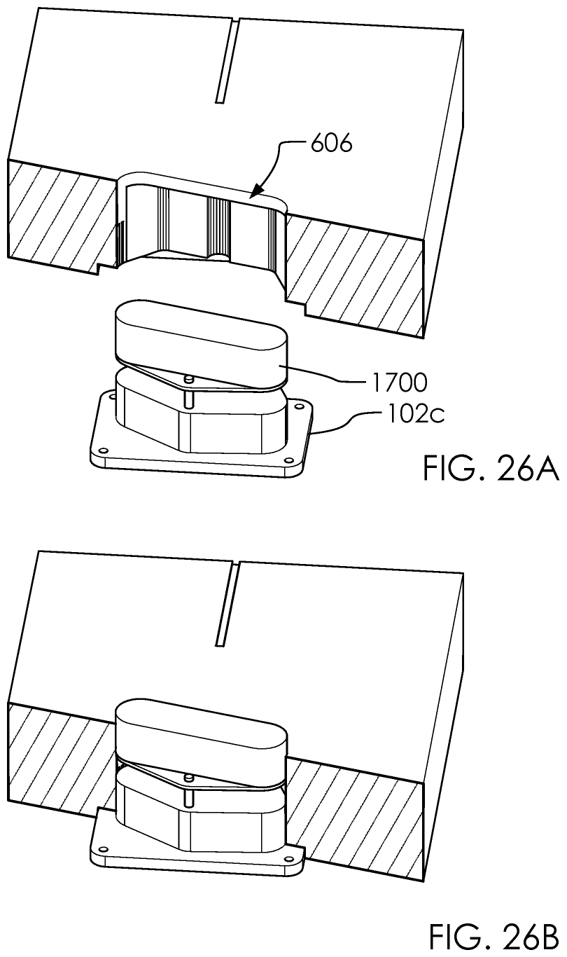

FIGS. 26A and 26B illustrate a perspective overview of said workpiece 1800 with said multi-tiered pickup cavity 106 aligned with said third plate 102c and said guitar pickup 1700, and said workpiece 1800 with said guitar pickup 1700 installed into said multi-tiered pickup cavity 106.

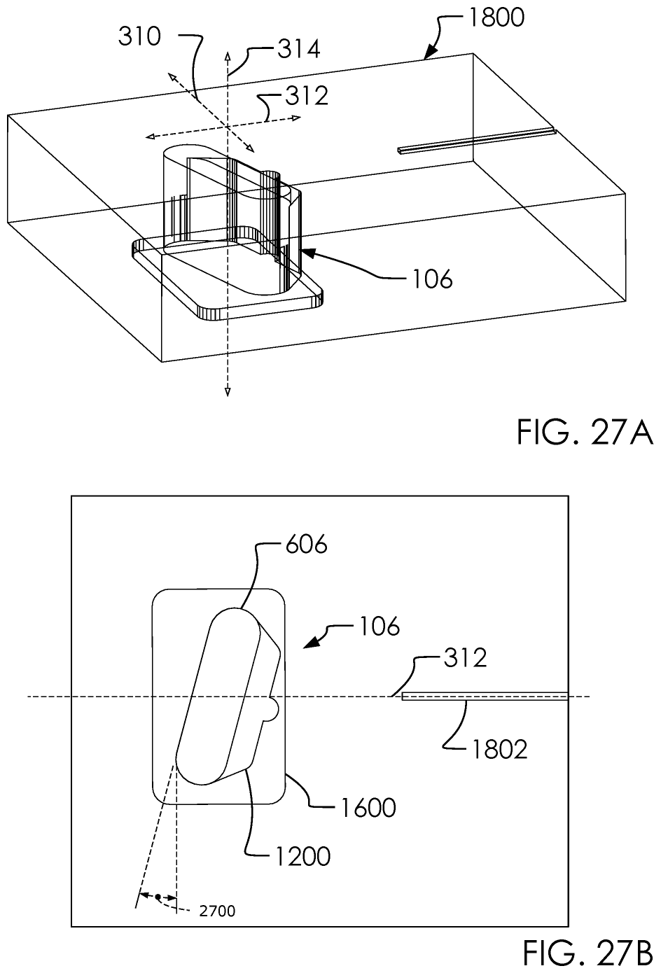

FIGS. 27A and 27B illustrate a wireframe perspective lower view and an elevated top wireframe view of said workpiece 1800 with said multi-tiered pickup cavity 106, respectively.

In one embodiment, said cavity routing tool assembly 100 can reorient one or more cuts about said z-axis 314 and relative to said y-axis 312 by arranging portions of said plurality of plates 102 and said plurality of plugs 104 around said z-axis 314. For example, said first cut 606 and said second cut 1200 can be at a rotary offset 2700 from said y-axis 312 whereas, side portions of said third cut 1600 can be aligned with said x-axis 310 and said y-axis 312.

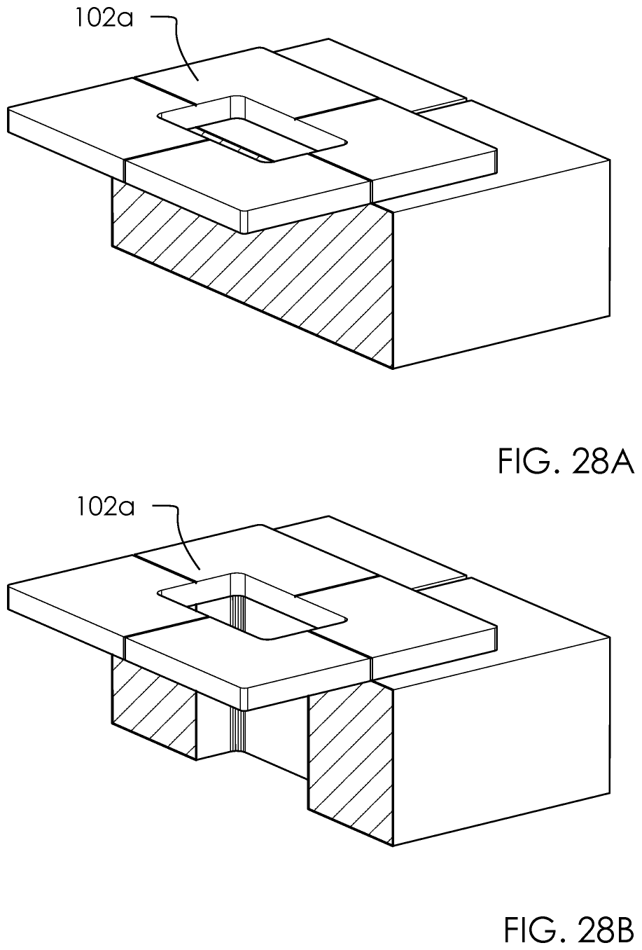

FIGS. 28A and 28B illustrate a cross-section perspective overview of said workpiece 1800 with said first plate 102a, with and without said first cut 606, respectively.

For FIGS. 28A-32B said workpiece 1800 can represent said first humbucker pickup 502 or said second humbucker pickup 504 of said humbucker style pickup arrangement 500. Wherein, said guitar pickup 1700 can comprise a rectangular cross-section. However, note the use of said plurality of plates 102 and said plurality of plugs 104 are substantially like those in use in FIGS. 6A-17C.

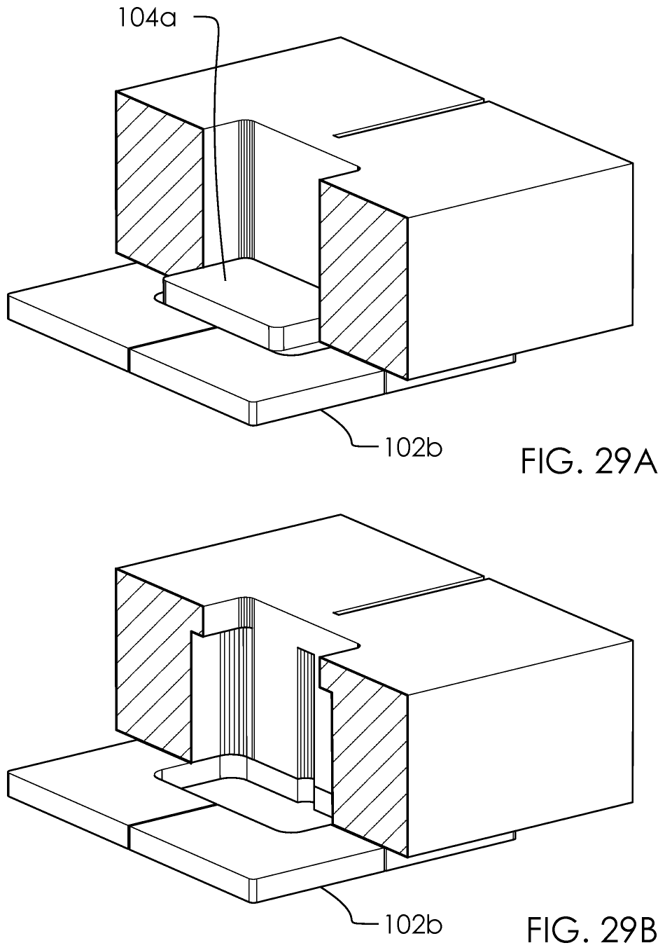

FIGS. 29A and 29B illustrate a cross-section perspective overview of said workpiece 1800 with said first plug 104a in said first cut 606 and said second plate 102b around a portion of said first plug 104a, and said second plate 102b with said second cut 1200.

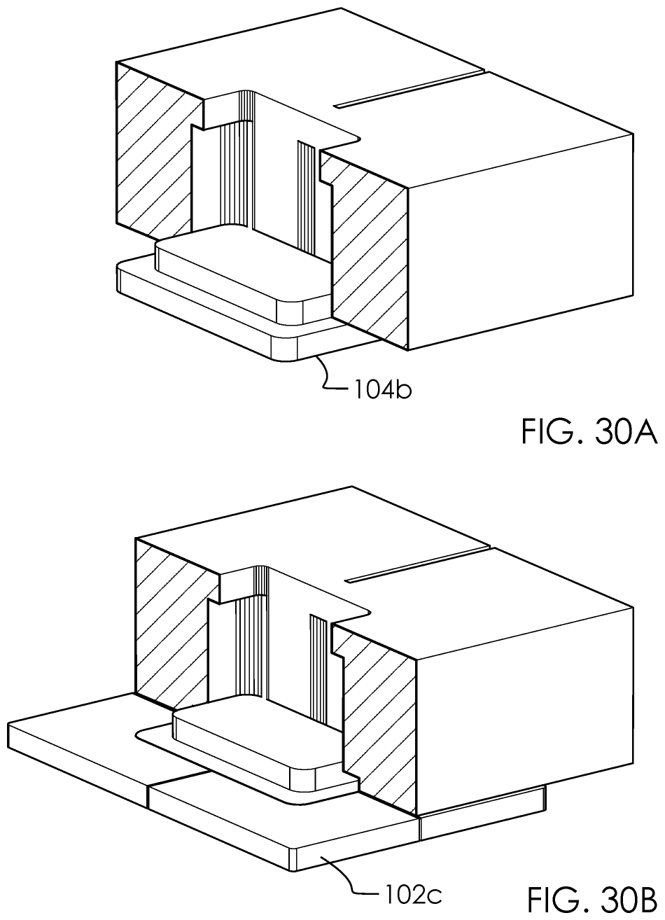

FIGS. 30A and 30B illustrate a cross-section perspective overview of said workpiece 1800 with said second plug 104b in said second cut 1200, and said third plate 102c around a portion of said second plug 104b.

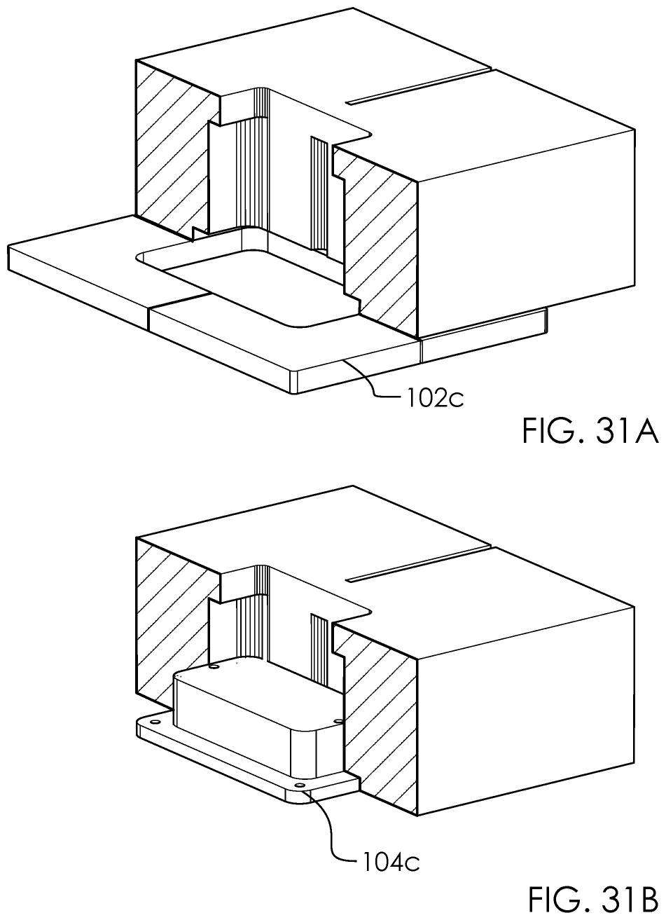

FIGS. 31A and 31B illustrate a cross-section perspective overview of said workpiece 1800 with said third plate 102c aligned with said third cut 1600, and said third plug 104c in said first cut 606.

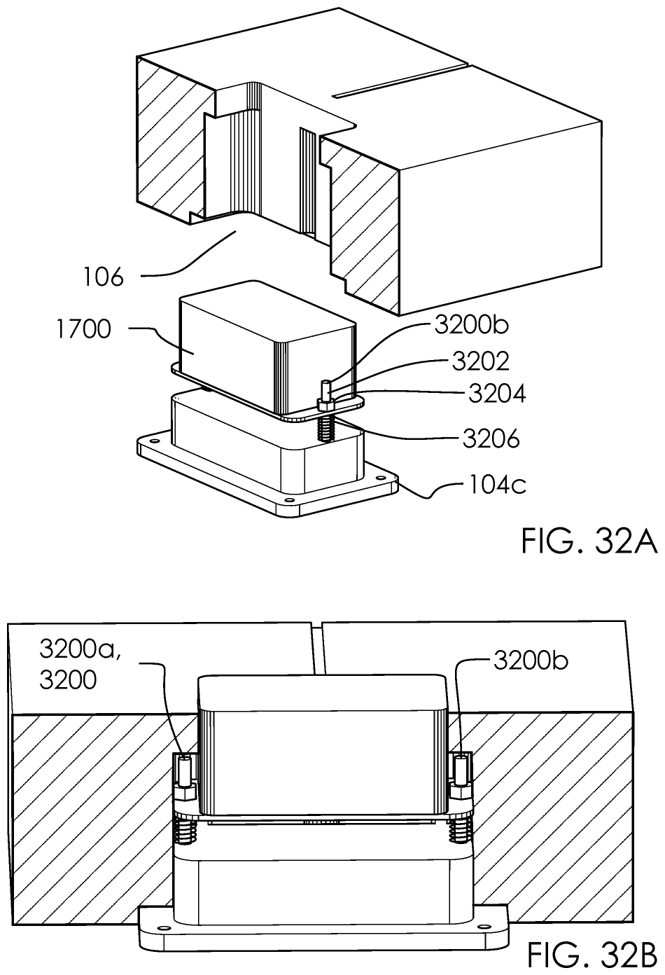

FIGS. 32A and 32B illustrate a cross-section perspective overview of said workpiece 1800 with said guitar pickup 1700 and said third plug 104c aligned with and installed in said multi-tiered pickup cavity 106, respectively.

In one embodiment, said guitar pickup 1700 can comprise two or more pickup attachment assemblies 3200 configured to attach said guitar pickup 1700 to said third plug 104c. As shown, said two or more pickup attachment assemblies 3200 can comprise a first pickup attachment assembly 3200a and a second pickup attachment assembly 3200b. Each among said two or more pickup attachment assemblies 3200 can comprise an extension 3202, a nut 3204 and a spring 3206. Wherein, said extension 3202 can be configured to hold said guitar pickup 1700 to said extension 3202; and said spring 3206 can separate said guitar pickup 1700 and said third plug 104c, as illustrated.

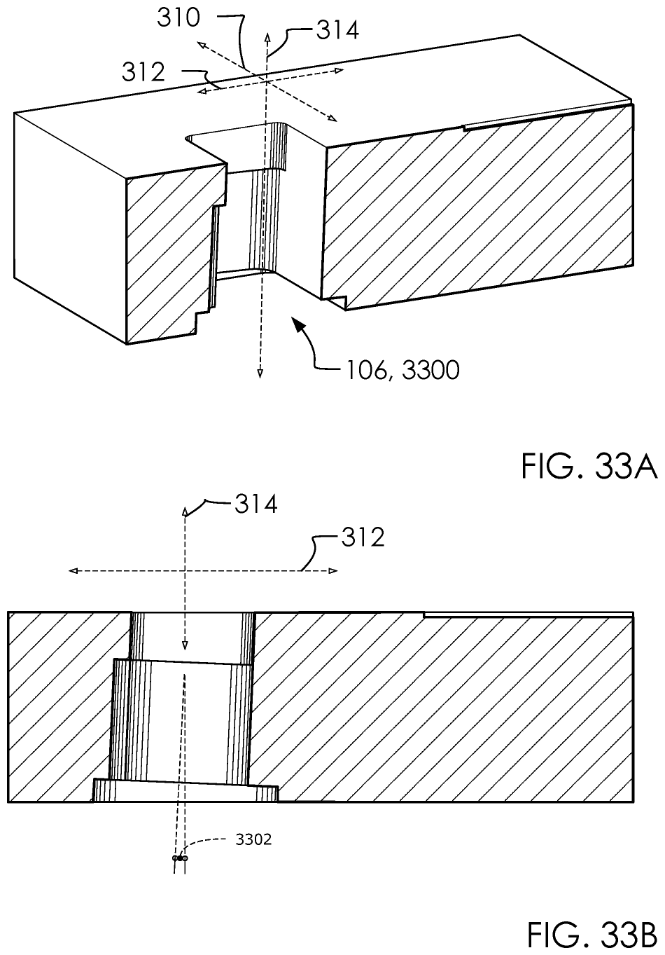

FIGS. 33A and 33B illustrate a perspective overview and an elevated side view in cross-section of said workpiece 1800 with a tilted configuration 3300 of said multi-tiered pickup cavity 106.

In one embodiment, said tilted configuration 3300 can comprise said multi-tiered pickup cavity 106 being at a z-offset 3302 relative to said z-axis 314. Wherein, said first cut 606, said second cut 1200 and said third cut 1600 can be substantially aligned with said z-offset 3302.

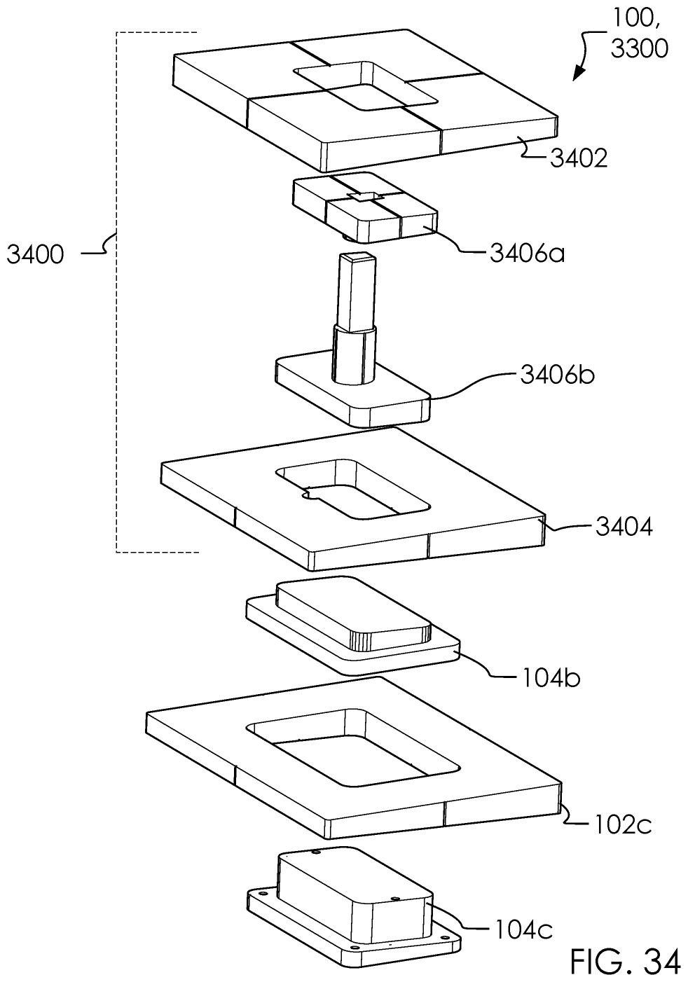

FIG. 34 illustrates an exploded perspective overview of said cavity routing tool assembly 100 in said tilted configuration 3300.

In one embodiment, said tilted configuration 3300 of said cavity routing tool assembly 100 can comprise an index system 3400 comprising a top index plate 3402, a bottom index plate 3404, and an index key assembly 3406. In one embodiment, said index key assembly 3406 can comprise a first index key 3406a and a second index key 3406b.

In one embodiment, said index system 3400 can be configured to align said top index plate 3402 with said bottom index plate 3404, as discussed herein. For example, said first index key 3406a and said second index key 3406b can connect to one another through said workpiece 1800 and align said top index plate 3402 with said bottom index plate 3404.

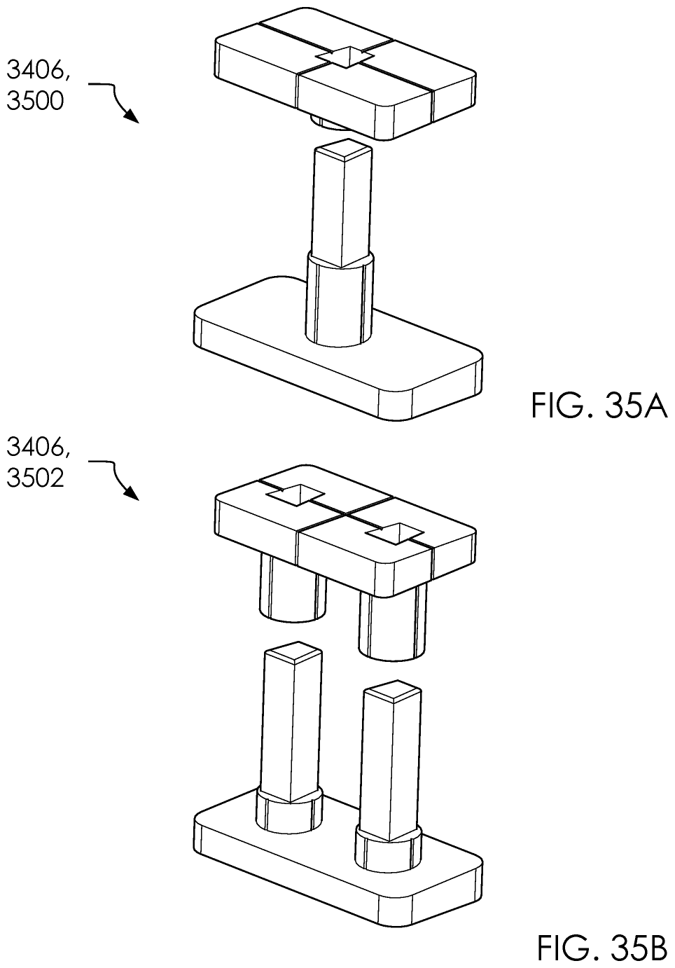

FIGS. 35A and 35B illustrate a single key configuration 3500 and a double key configuration 3502 of said index key assembly 3406, respectively.

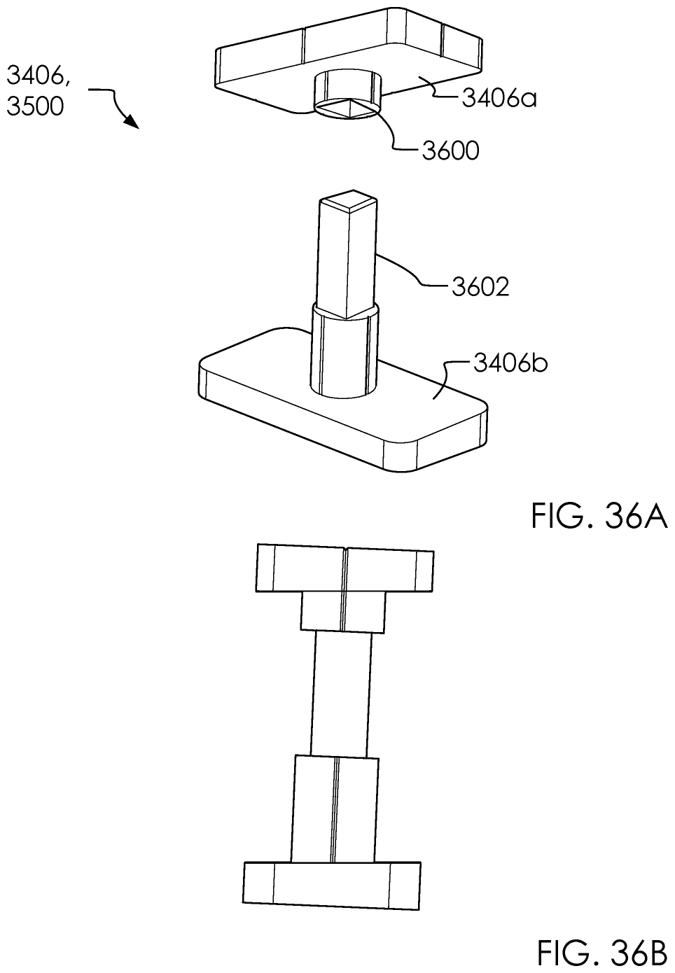

FIGS. 36A and 36B illustrate first view of said single key configuration 3500 showing a bottom side of said first index key 3406a and a top view of said second index key 3406b and an elevated side view of said single key configuration 3500 assembled.

In one embodiment, one among said index key assembly 3406 can comprise a key slot 3600 and the other can comprise a key extension 3602. For example, said first index key 3406a can comprise said key slot 3600 and said second index key 3406b can comprise said key extension 3602, as illustrated. Wherein, said key extension 3602 can selectively align and mate with said key slot 3600.

In one embodiment, said key slot 3600 and said key extension 3602 can comprise a single orientation fit configured to only allow 3 said first side 602 to fit into 3 said cutting location 600 in one configuration. For example, said key slot 3600 can comprise a female trapezoid cross-section and 3 said cutting location 600 can comprise a male trapezoid cross-section, as illustrated.

Said first index key 3406a can comprise a first key plug 3604a and said second index key 3406b can comprise a second key plug 3604b.

In one embodiment, components in said index key assembly 3406 can selectively mate and slide relative to one another. With said key slot 3600 mated with said key extension 3602, said index key assembly 3406 is configured to maintain alignment said first key plug 3604a and said second key plug 3604b.

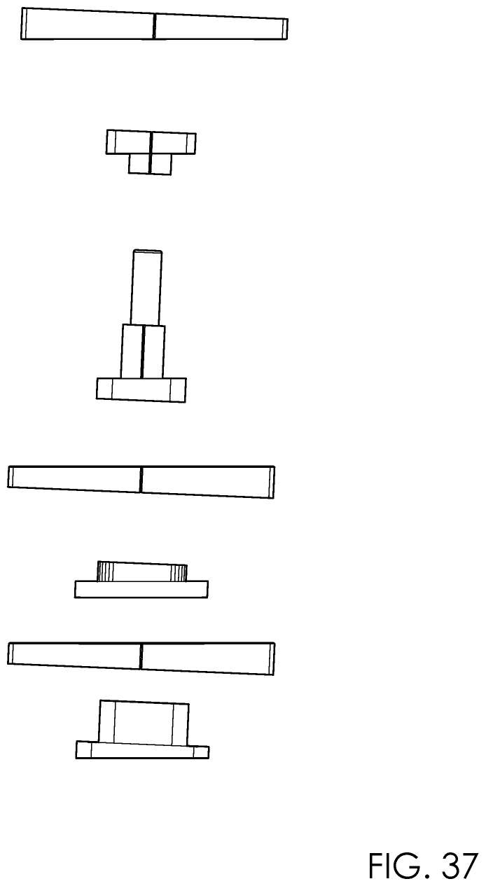

FIG. 37 illustrates an exploded elevated side view of said cavity routing tool assembly 100 having said index system 3400.

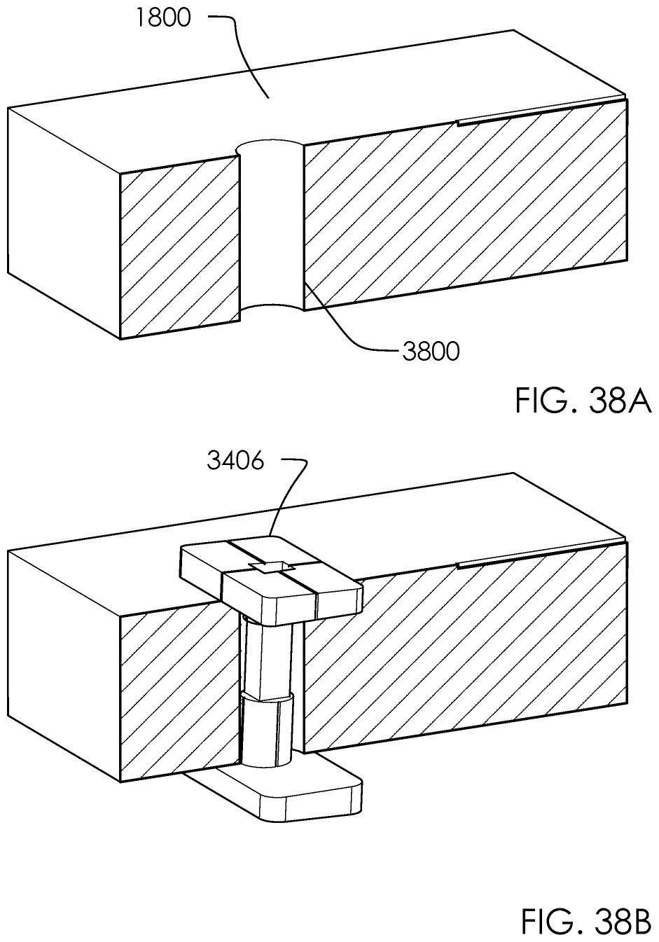

FIGS. 38A and 38B illustrate a perspective overview of said workpiece 1800 having a pilot aperture 3800, viewed without and with said index key assembly 3406, respectively.

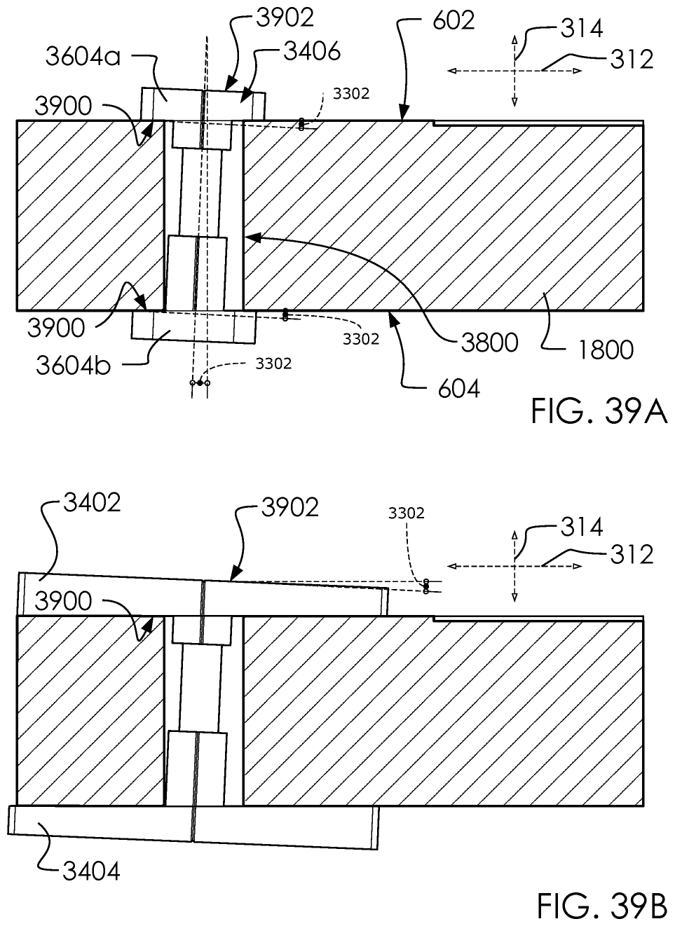

FIGS. 39A and 39B illustrate a cross-section elevated side view of said workpiece 1800 with said pilot aperture 3800 and portions of said index system 3400.

In one embodiment, installing said cavity routing tool assembly 100 into said workpiece 1800 can comprise drilling said pilot aperture 3800 at said cutting location 600, installing said index key assembly 3406 into said pilot aperture 3800, attaching said top index plate 3402 to said first index key 3406a, attaching said bottom index plate 3404 to said second index key 3406b and using said index key assembly 3406 to align said routing cavity 202 of said top index plate 3402 with said routing cavity 202 of said bottom index plate 3404.

One feature of said index system 3400 can comprise an alignment with said z-offset 3302, relative to said z-axis 314. For example, said first key plug 3604a and said second key plug 3604b can comprise a trapezoid cross-section in said y-axis 312 and said z-axis 314 with a proximate interior side 3900 being aligned with said y-axis 312 and the remaining sides being offset by said z-offset 3302. Wherein, said proximate interior side 3900 comprises a surface adjacent to said workpiece 1800. Said index key assembly 3406 further comprises and a distal exterior side 3902 being away from said pilot aperture 3800 and substantially on the top and bottom sides of said index key assembly 3406. Accordingly, with said index key assembly 3406 installed into said pilot aperture 3800: said proximate interior side 3900 sits flat against said first side 602 and said second side 604 of said workpiece 1800; said first key plug 3604a and said second key plug 3604b are aligned with said z-offset 3302; and said distal exterior side 3902 of said index key assembly 3406 can be offset from said y-axis 312 by an angle equal to said z-offset 3302.

Likewise, said top index plate 3402 and said bottom index plate 3404 comprise a similar cross-section trapezoid shape as said first key plug 3604a and said second key plug 3604b. Accordingly, with said top index plate 3402 and said bottom index plate 3404 attached to said index key assembly 3406: said proximate interior side 3900 sit flat on said first side 602 and said second side 604 of said workpiece 1800; said distal exterior side 3902 of said top index plate 3402 and said bottom index plate 3404 can be offset from said y-axis 312 by an angle equal to said z-offset 3302; and said routing cavity 202 of said top index plate 3402 and said bottom index plate 3404 are aligned with said z-offset 3302 from said z-axis 314.

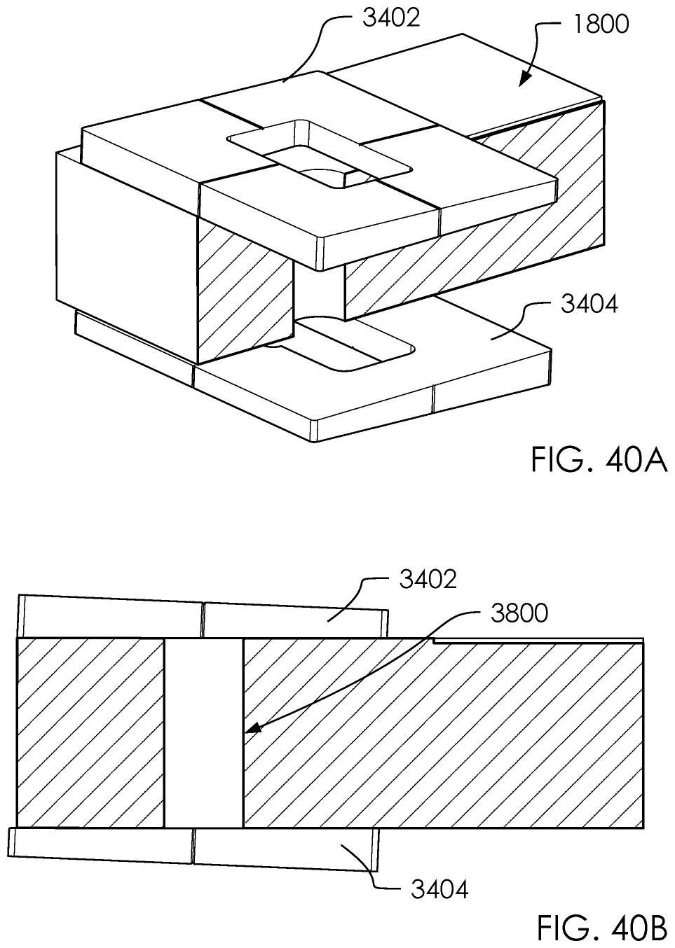

FIGS. 40A and 40B illustrate a cross-section perspective overview of said workpiece 1800 having said pilot aperture 3800 with said top index plate 3402 and said bottom index plate 3404 attached to said first side 602 and said second side 604 of said workpiece 1800.

In one embodiment, said top index plate 3402 and said bottom index plate 3404 can be attached to said workpiece 1800 with adhesive or tape before removing said index key assembly 3406 from said pilot aperture 3800.

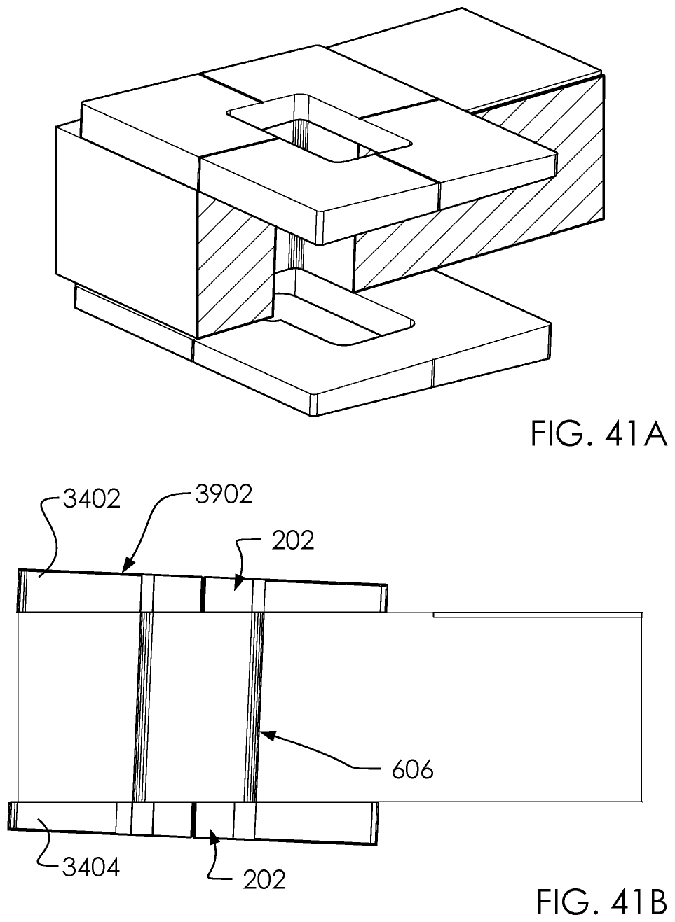

FIGS. 41A and 41B illustrate a cross-section perspective overview and wireframe elevated side view of said workpiece 1800 having said first cut 606 cut through said top index plate 3402.

Said top index plate 3402 can be configured to align a routing tool by aligning said distal exterior side 3902 with said z-offset 3302. For example, by using a router on said distal exterior side 3902 of said top index plate 3402 and through said routing cavity 202, said first cut 606 can be cut into said workpiece 1800 at said z-offset 3302. In one embodiment, said routing cavity 202 of 3 said single p-rails pickup 402 and said bottom index plate 3404 can be aligned to ensure said first cut 606 and said second cut 1200 are aligned.

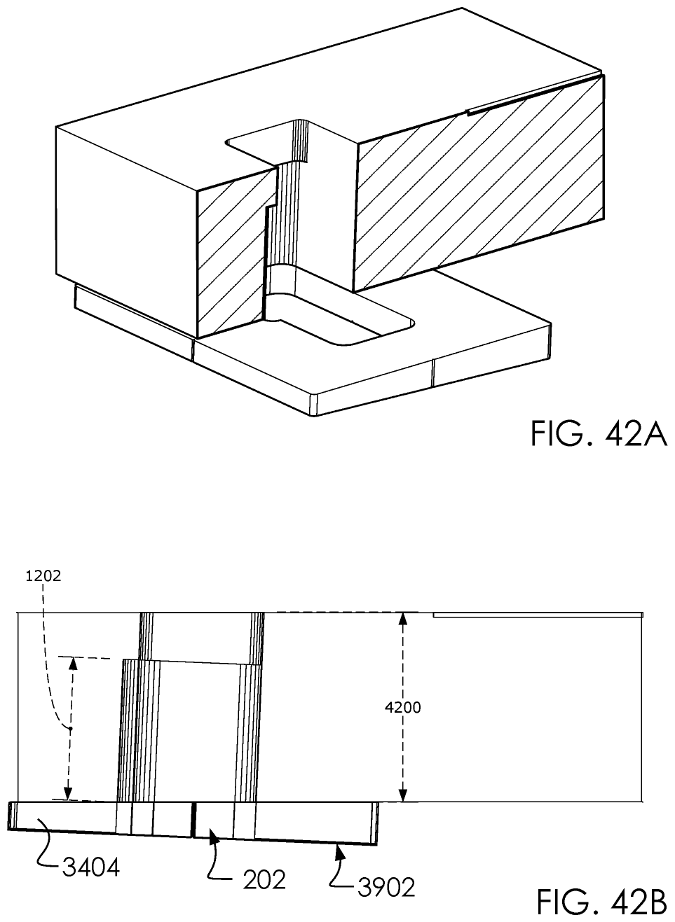

FIGS. 42A and 42B illustrate a cross-section perspective overview and wireframe elevated side view of said workpiece 1800 having said second cut 1200 cut through said bottom index plate 3404.

Said cavity routing tool assembly 100 can be configured to cut said second cut 1200 at said z-offset 3302 by: removing said top index plate 3402 from said first side 602 of said workpiece 1800, and routing said second cut 1200 through said bottom index plate 3404 to said second cut depth 1202 relative to said distal exterior side 3902. Wherein, said second cut depth 1202 is less than a workpiece thickness 4200.

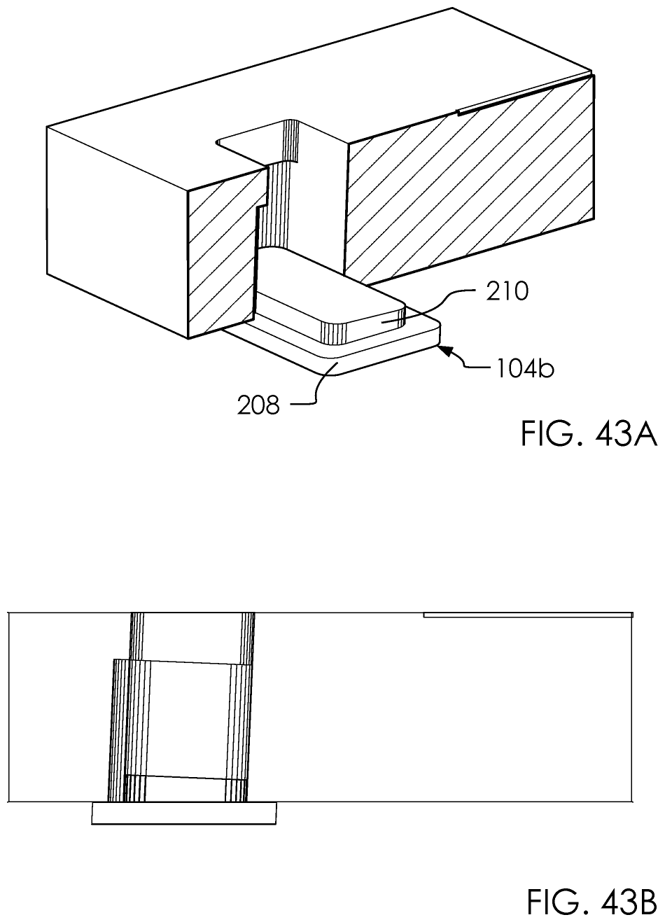

FIGS. 43A and 43B illustrate a cross-section perspective overview and wireframe elevated side view of said workpiece 1800 with a portion of said second plug 104b inserted into said second cut 1200.

In one embodiment, said upper plug portion 210 can be aligned with said first cut 606 and offset from said lower plug portion 208 by said z-offset 3302.

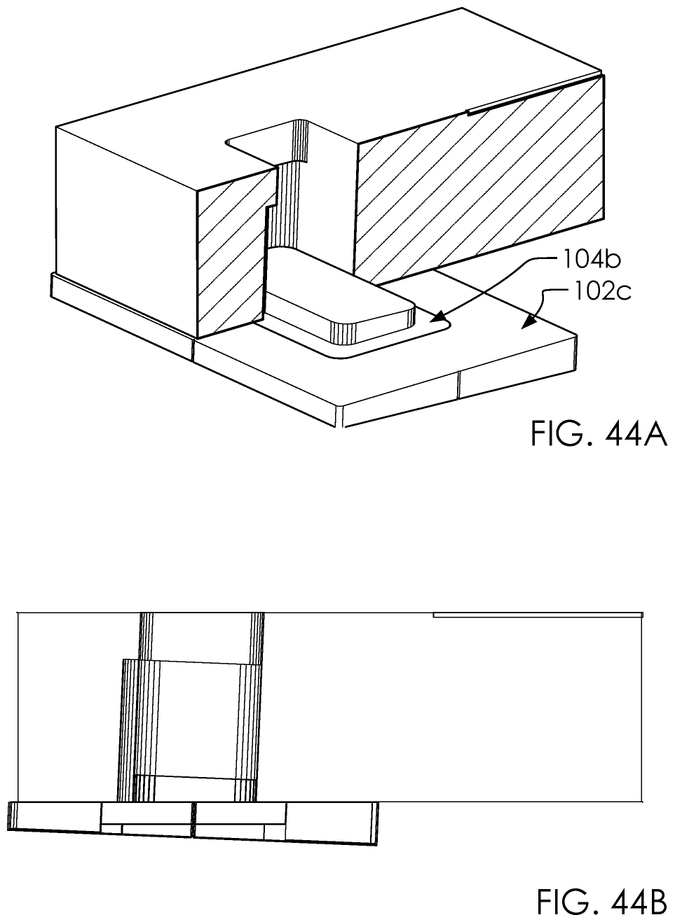

FIGS. 44A and 44B illustrate a cross-section perspective overview and wireframe elevated side view of said workpiece 1800 with a portion of said second plug 104b inserted into said second cut 1200 and said third plate 102c installed around a portion of said second plug 104b.

In one embodiment, said routing cavity 202 of said third plate 102c can selectively slide around said upper plug portion 210 of said second plug 104b.

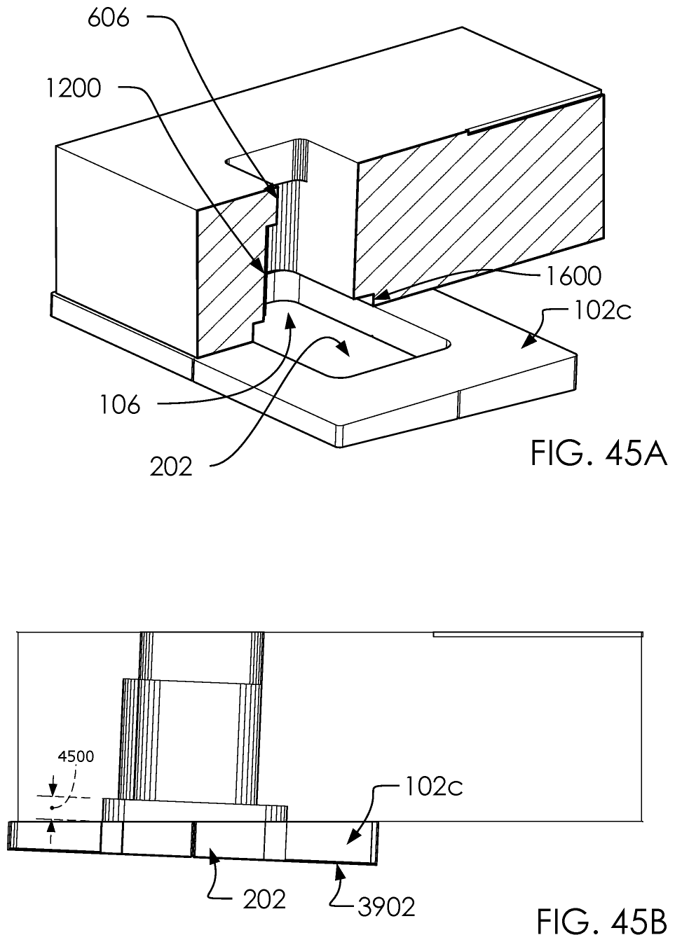

FIGS. 45A and 45B illustrate a cross-section perspective overview and wireframe elevated side view of said workpiece 1800 and said third plate 102c, with said third cut 1600 in said workpiece 1800.

In one embodiment, said third plate 102c can comprise said proximate interior side 3900 configured to lay flat against said second side 604 of said workpiece 1800; and said routing cavity 202 and said distal exterior side 3902 are offset from said z-axis 314 by said z-offset 3302 to ensure said third cut 1600 is aligned with said first cut 606 and said second cut 1200.

Accordingly, said third plate 102c can be configured to align with said second cut 1200 using said second plug 104b, and guide a router along said distal exterior side 3902 and through said routing cavity 202 to form said third cut 1600 to a third cut depth 4500.

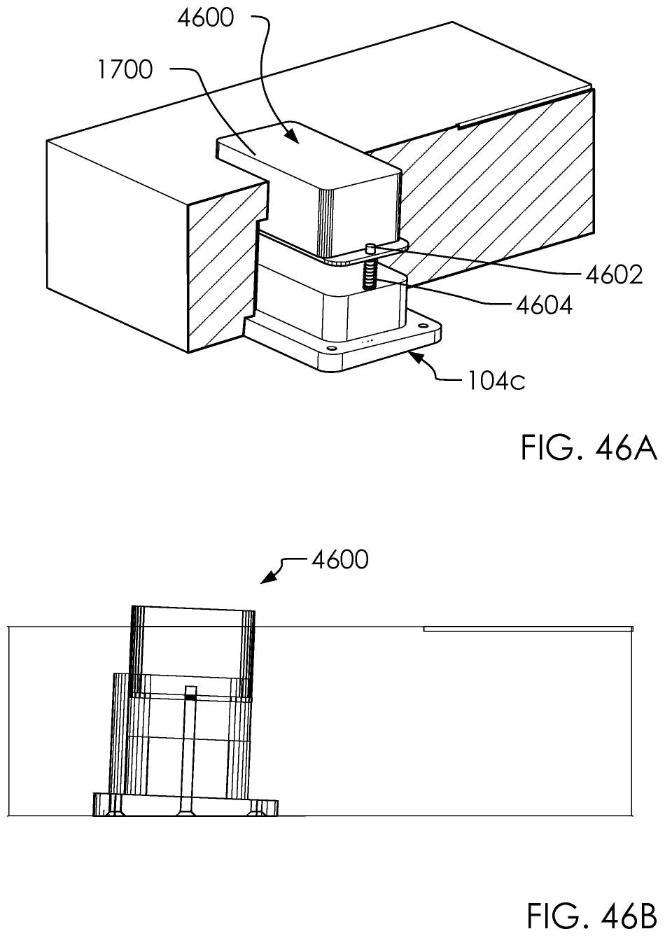

FIGS. 46A and 46B illustrate a cross-section perspective overview and wireframe elevated side view of said workpiece 1800, with said third plug 104c and said guitar pickup 1700 installed.

In one embodiment, said third plug 104c and said guitar pickup 1700 can comprise an installed pickup assembly 4600. In one embodiment, said installed pickup assembly 4600 can further comprise one or more fasteners 4602 and one or more springs 4604. Said one or more fasteners 4602 can be configured to attach said guitar pickup 1700 to said third plug 104c. Said one or more springs 4604 can be installed around said one or more fasteners 4602 and between said guitar pickup 1700 and said third plug 104c. Said one or more springs 4604 can be configured to absorb shocks to said guitar pickup 1700 and realign said guitar pickup 1700 relative to said first side 602.

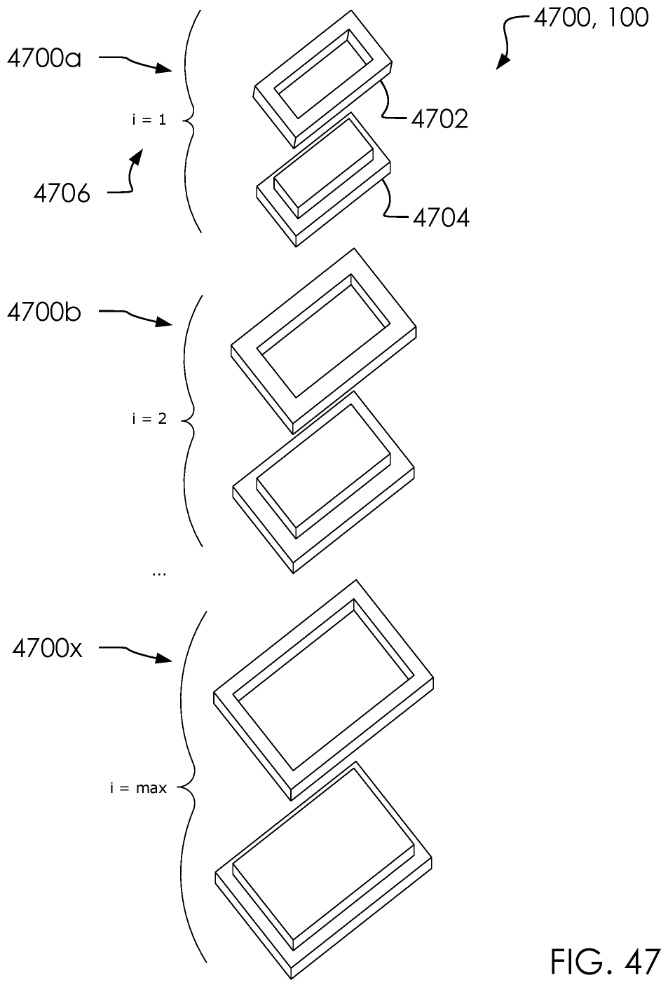

FIG. 47 illustrates an elevated overview of said cavity routing tool assembly 100, presented as two or more plug-plate sets 4700.

In one embodiment, said cavity routing tool assembly 100 can comprise said two or more plug-plate sets 4700, each comprising a plate 4702 and a plug 4704.

As illustrated, said two or more plug-plate sets 4700 can be referred to using a set integer 4706 comprising an identifier for each set. Accordingly, a first plug-plate set 4700a can comprise a first among said two or more plug-plate sets 4700 wherein said set integer 4706 equals one. Further wherein, said first plug-plate set 4700a can comprise said first plate 102a and said first plug 104a.

Likewise, a last plug plate set 4700x can comprise a last among said two or more plug-plate sets 4700 where said set integer 4706 is the highest value within said two or more plug-plate sets 4700.

In one embodiment, said set integer 4706 for said last plug plate set 4700x can comprise three. Wherein, said two or more plug-plate sets 4700 comprises said first plug-plate set 4700a, a second plug-plate set 4700b and a third plug-plate set 4700c, as illustrated in most FIGS. 1-33B.

Each among said two or more plug-plate sets 4700 can be designed in relationship to one another. For discussion, a current set and a next set comprise plug plate sets having sequential counts of said set integer 4706, such as one and two or two and three.

Accordingly, said two or more plug-plate sets 4700 each comprise said plate 4702 and said plug 4704; with regard to said current set, said routing cavity 202 of said plate 4702 is configured selectively attach to a portion of said workpiece 1800 and align a current cut among said multi-tiered pickup cavity 106 into said workpiece 1800; said plate 4702 is configured to be removed from said workpiece 1800; said upper plug portion 210 of said plug 4704 of said current set is configured to align and fit into said current cut; whereupon, said lower plug portion 208 of said plug 4704 in said current set is configured to align with and fit within said routing cavity 202 of said plate 4702 of said next set.

Thus, said two or more plug-plate sets 4700 are configured to align each said routing cavity 202 among said plurality of plates 102 using said plurality of plugs 104.

Further wherein, said plug 4704 of said last plug plate set 4700x can comprise said mounting bracket 1704 for said guitar pickup 1700, as previously discussed.

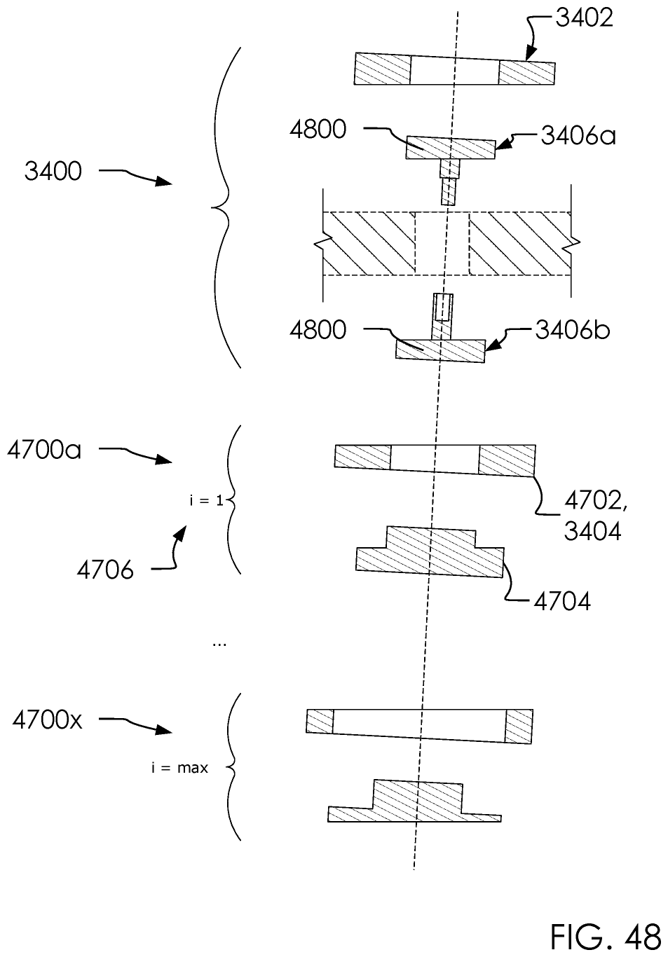

FIG. 48 illustrates a cross-section elevated side view of said cavity routing tool assembly 100 with said index system 3400 and said two or more plug-plate sets 4700.

In one embodiment, said cavity routing tool assembly 100 can comprise said index system 3400 and said two or more plug-plate sets 4700.

With reference to the earlier discussion, said bottom index plate 3404 of said index system 3400 can comprise said plate 4702 of said first plug-plate set 4700a. Said index system 3400 can comprise said top index plate 3402, and said index key assembly 3406 having said first index key 3406a and said second index key 3406b.

Said index system 3400 and said two or more plug-plate sets 4700 can interact to align said plurality of plates 102 with one another where said z-offset 3302 does not align with said z-axis 314 when forming said multi-tiered pickup cavity 106. For example, said index system 3400 can align said top index plate 3402 with said bottom index plate 3404 by installing said first index key 3406a into said second index key 3406b through said pilot aperture 3800, aligning and securing said routing cavity 202 of said top index plate 3402 with a plug portion 4800 of said first index key 3406a, and aligning and securing said plate 4702 of said first plug-plate set 4700a to said second index key 3406b by sliding said routing cavity 202 of said plate 4702 around said plug portion 4800 of said index key assembly 3406. Having aligned said index system 3400 with said first plug-plate set 4700a, said cavity routing tool assembly 100 can be used to complete the construction of said multi-tiered pickup cavity 106 by keeping said routing cavity 202 of said plurality of plates 102 aligned with one another using said plurality of plugs 104, as discussed above.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

### PARTS LIST

said cavity routing tool assembly 100,
said plurality of plates 102,
said plurality of plugs 104,
said multi-tiered pickup cavity 106,
said guitar body 108,
said first plate 102a,
said second plate 102b,
said third plate 102c,
said first plug 104a,
said second plug 104b,
said third plug 104c,
said plate body 200,
said routing cavity 202,
said one or more alignment markings 204,
said first alignment marking 204a,
said second alignment marking 204b,
said exterior surface 220,
said top surface 206,
said lower plug portion 208,
said upper plug portion 210,
said upper portion horizontal cross-section 212,
said router cavity horizontal cross-section 214,
said first width 216,
said first depth 218,
said s-style pickup arrangement 300,
said guitar 302,
said neck pickup 304,
said middle pickup 306,
said bridge pickup 308,
said x-axis 310,
said y-axis 312,
said z-axis 314,
said p-90 style pickup arrangement 400,
said single p-rails pickup 402,
said humbucker style pickup arrangement 500,
said first humbucker pickup 502,
said second humbucker pickup 504,
said cutting location 600,
said first side 602,
said first cut 606,
said second side 604,
said first end 902,
said second end 904,
said second cut 1200,
said second cut depth 1202,
said third cut 1600,
said guitar pickup 1700,
said negative representation 1702,
said mounting bracket 1704,
said workpiece 1800,
said alignment mark 1802,
said non-perpendicular pickup cavity 1900,
said rotary offset 2700,
said two or more pickup attachment assemblies 3200,
said first pickup attachment assembly 3200a,
said second pickup attachment assembly 3200b,
said extension 3202,
said nut 3204,
said spring 3206,
said tilted configuration 3300,
said z-offset 3302,
said index system 3400,
said top index plate 3402,
said bottom index plate 3404,
said index key assembly 3406,
said first index key 3406a,
said second index key 3406b,
said single key configuration 3500,
said double key configuration 3502,
said key slot 3600,
said key extension 3602,
said first key plug 3604a,
said second key plug 3604b,
said pilot aperture 3800,
said proximate interior side 3900,
said distal exterior side 3902,
said workpiece thickness 4200,
said third cut depth 4500,
said installed pickup assembly 4600,
said one or more fasteners 4602,
said one or more springs 4604,
said two or more plug-plate sets 4700,
said plate 4702,
said plug 4704,
said set integer 4706,
said first plug-plate set 4700a,
said last plug plate set 4700x,
said second plug-plate set 4700b,
said third plug-plate set 4700c, and
said plug portion 4800.

Preferred embodiments, written with reference to the original claims:
said cavity routing tool assembly 100 for aligning said plurality of plates 102 with one another in a preconfigured manner using said plurality of plugs 104 to cut said multi-tiered pickup cavity 106 into said workpiece 1800. Said cavity routing tool assembly 100 comprises said two or more plug-plate sets 4700, each comprising said plate 4702 and said plug 4704. Said plate 4702 collectively across all said two or more plug-plate sets 4700 can be referred to as said plurality of plates 102, and said plug 4704 can be referred to as said plurality of plugs 104. Said plurality of plugs 104 can be configured to align and guide router cuts to form said multi-tiered pickup cavity 106 in said workpiece 1800. Each among said plurality of plates 102 can be configured to selectively align with portions of said plurality of plugs 104 and ensure said multi-tiered pickup cavity 106 can be correctly formed in said workpiece 1800. Each among said plurality of plates 102 comprises said plate body 200, and said routing cavity 202. Each among said plurality of plugs 104 comprises said lower plug portion 208 and said upper plug portion 210. Said two or more plug-plate sets 4700 can be referred to using said set integer 4706 comprising an identifier for each set, wherein said first plug-plate set 4700a comprises a first among said two or more plug-plate sets 4700 wherein said set integer 4706 equals one, and said last plug plate set 4700x comprises a last among said two or more plug-plate sets 4700 where said set integer 4706 can be the highest value within said two or more plug-plate sets 4700. Each among said two or more plug-plate sets 4700 can be designed in relationship to one another. Regarding said two or more plug-plate sets 4700, a current set and a next set comprise plug plate sets having sequential counts of said set integer 4706. Said two or more plug-plate sets 4700 each comprise said plate 4702 and said plug 4704. Regarding said current set, said routing cavity 202 of said plate 4702 can be configured to selectively attach to a portion of said workpiece 1800 and align a current cut among said multi-tiered pickup cavity 106 into said workpiece 1800, said plate 4702 can be configured to be removed from said workpiece 1800, and said upper plug portion 210 of said plug 4704 of said current set can be configured to align and fit into said current cut. Regarding the interaction of said current set with said next set, said lower plug portion 208 of said plug 4704 in said current set can be configured to align with and fit within said routing cavity 202 of said plate 4702 of said next set. Said two or more plug-plate sets 4700 can be configured in the relationships described as said current set and said next set from said first plug-plate set 4700a to said last plug plate set 4700x. Said current cut for said first plug-plate set 4700a comprise said cutting location 600 in said workpiece 1800. Said multi-tiered pickup cavity 106 comprises the sum of each said current cut in said workpiece 1800 for each among said plurality of plates 102 in said two or more plug-plate sets 4700. Said two or more plug-plate sets 4700 can be configured to align each said routing cavity 202 among said plurality of plates 102 using said plurality of plugs 104. Said one or more alignment markings 204 can be displayed in said exterior surface 220 of said plurality of plates 102. Said upper plug portion 210 of said plurality of plugs 104 can be smaller than said lower plug portion 208 of said plurality of plugs 104. Said set integer 4706 for said last plug plate set 4700x comprises three. Said two or more plug-plate sets 4700 comprises said first plug-plate set 4700a, said second plug-plate set 4700b and said third plug-plate set 4700c. Said third plug-plate set 4700c comprises said last plug plate set 4700x.

Said cavity routing tool assembly 100 for aligning said plurality of plates 102 with one another in a preconfigured manner using said plurality of plugs 104 to cut said multi-tiered pickup cavity 106 into said workpiece 1800. Said cavity routing tool assembly 100 comprises said two or more plug-plate sets 4700, each comprising said plate 4702 and said plug 4704. Said plate 4702 collectively across all said two or more plug-plate sets 4700 can be referred to as said plurality of plates 102, and said plug 4704 can be referred to as said plurality of plugs 104. Said plurality of plugs 104 can be configured to align and guide router cuts to form said multi-tiered pickup cavity 106 in said workpiece 1800. Each among said plurality of plates 102 can be configured to selectively align with portions of said plurality of plugs 104 and ensure said multi-tiered pickup cavity 106 can be correctly formed in said workpiece 1800. Each among said plurality of plates 102 comprises said plate body 200, and said routing cavity 202. Each among said plurality of plugs 104 comprises said lower plug portion 208 and said upper plug portion 210. Said two or more plug-plate sets 4700 can be referred to using said set integer 4706 comprising an identifier for each set, wherein said first plug-plate set 4700a comprises a first among said two or more plug-plate sets 4700 wherein said set integer 4706 equals one, and said last plug plate set 4700x comprises a last among said two or more plug-plate sets 4700 where said set integer 4706 can be the highest value within said two or more plug-plate sets 4700. Each among said two or more plug-plate sets 4700 can be designed in relationship to one another. Regarding said two or more plug-plate sets 4700, a current set and a next set comprise plug plate sets having sequential counts of said set integer 4706. Said two or more plug-plate sets 4700 each comprise said plate 4702 and said plug 4704. Regarding said current set, said routing cavity 202 of said plate 4702 can be configured to selectively attach to a portion of said workpiece 1800 and align a current cut among said multi-tiered pickup cavity 106 into said workpiece 1800, said plate 4702 can be configured to be removed from said workpiece 1800, and said upper plug portion 210 of said plug 4704 of said current set can be configured to align and fit into said current cut. Regarding the interaction of said current set with said next set, said lower plug portion 208 of said plug 4704 in said current set can be configured to align with and fit within said routing cavity 202 of said plate 4702 of said next set. Said two or more plug-plate sets 4700 can be configured in the relationships described as said current set and said next set from said first plug-plate set 4700a to said last plug plate set 4700x. Said current cut for said first plug-plate set 4700a comprise said cutting location 600 in said workpiece 1800. Said multi-tiered pickup cavity 106 comprises the sum of each said current cut in said workpiece 1800 for each among said plurality of plates 102 in said two or more plug-plate sets 4700. Said two or more plug-plate sets 4700 can be configured to align each said routing cavity 202 among said plurality of plates 102 using said plurality of plugs 104. Said one or more alignment markings 204 can be displayed in said exterior surface 220 of said plurality of plates 102. Said upper plug portion 210 of said plurality of plugs 104 can be smaller than said lower plug portion 208 of said plurality of plugs 104. Said set integer 4706 for said last plug plate set 4700x comprises three. Said two or more plug-plate sets 4700 comprises said first plug-plate set 4700a, said second plug-plate set 4700b and said third plug-plate set 4700c. Said third plug-plate set 4700c comprises said last plug plate set 4700x.

Said cavity routing tool assembly 100 for aligning said plurality of plates 102 with one another in a preconfigured manner using said plurality of plugs 104 to cut said multi-tiered pickup cavity 106 into said workpiece 1800. Said cavity routing tool assembly 100 comprises said two or more plug-plate sets 4700, each comprising said plate 4702 and said plug 4704. Said plate 4702 collectively across all said two or more plug-plate sets 4700 can be referred to as said plurality of plates 102, and said plug 4704 can be referred to as said plurality of plugs 104. Said plurality of plugs 104 can be configured to align and guide router cuts to form said multi-tiered pickup cavity 106 in said workpiece 1800. Each among said plurality of plates 102 can be configured to selectively align with portions of said plurality of plugs 104 and ensure said multi-tiered pickup cavity 106 can be correctly formed in said workpiece 1800. Each among said plurality of plates 102 comprises said plate body 200, and said routing cavity 202. Each among said plurality of plugs 104 comprises said lower plug portion 208 and said upper plug portion 210. Said two or more plug-plate sets 4700 can be referred to using said set integer 4706 comprising an identifier for each set, wherein said first plug-plate set 4700a comprises a first among said two or more plug-plate sets 4700 wherein said set integer 4706 equals one, and said last plug plate set 4700x comprises a last among said two or more plug-plate sets 4700 where said set integer 4706 can be the highest value within said two or more plug-plate sets 4700. Each among said two or more plug-plate sets 4700 can be designed in relationship to one another. Regarding said two or more plug-plate sets 4700, a current set and a next set comprise plug plate sets having sequential counts of said set integer 4706. Said two or more plug-plate sets 4700 each comprise said plate 4702 and said plug 4704. Regarding said current set, said routing cavity 202 of said plate 4702 can be configured to selectively attach to a portion of said workpiece 1800 and align a current cut among said multi-tiered pickup cavity 106 into said workpiece 1800, said plate 4702 can be configured to be removed from said workpiece 1800, and said upper plug portion 210 of said plug 4704 of said current set can be configured to align and fit into said current cut. Regarding the interaction of said current set with said next set, said lower plug portion 208 of said plug 4704 in said current set can be configured to align with and fit within said routing cavity 202 of said plate 4702 of said next set. Said two or more plug-plate sets 4700 can be configured in the relationships described as said current set and said next set from said first plug-plate set 4700a to said last plug plate set 4700x. Said current cut for said first plug-plate set 4700a comprise said cutting location 600 in said workpiece 1800. Said multi-tiered pickup cavity 106 comprises the sum of each said current cut in said workpiece 1800 for each among said plurality of plates 102 in said two or more plug-plate sets 4700. Said two or more plug-plate sets 4700 can be configured to align each said routing cavity 202 among said plurality of plates 102 using said plurality of plugs 104.

Each among said plurality of plates 102 comprises said one or more alignment markings 204. Said one or more alignment markings 204 comprises said first alignment marking 204a and said second alignment marking 204b. Said first alignment marking 204a and said second alignment marking 204b can be perpendicular.

Said one or more alignment markings 204 can be displayed in said exterior surface 220 of said plurality of plates 102.

Said upper plug portion 210 of said plurality of plugs 104 can be smaller than said lower plug portion 208 of said plurality of plugs 104.

Said upper portion horizontal cross-section 212 of said upper plug portion 210 of said plug 4704 can match said router cavity horizontal cross-section 214 of said routing cavity 202 of said plate 4702.

Said cavity routing tool assembly 100 can be configured to align with each said routing cavity 202 of said plurality of plates 102 using said plurality of plugs 104 by: inserting a portion of said upper plug portion 210 into a portion of said multi-tiered pickup cavity 106, and inserting a portion of said lower plug portion 208 into another among said plurality of plates 102.

For each among said two or more plug-plate sets 4700, said lower plug portion 208 comprises a larger perimeter than said upper plug portion 210 of said plate 4702.

Said set integer 4706 for said last plug plate set 4700x comprises three. Said two or more plug-plate sets 4700 comprises said first plug-plate set 4700a, said second plug-plate set 4700b and said third plug-plate set 4700c. Said third plug-plate set 4700c comprises said last plug plate set 4700x.

Said multi-tiered pickup cavity 106 comprises a cumulative cavity by cuts made using said plate 4702 in said first plug-plate set 4700a, said second plug-plate set 4700b and said third plug-plate set 4700c. Said plug 4704 of said third plug-plate set 4700c comprises said mounting bracket 1704 for mounting said guitar pickup 1700 int said workpiece 1800 within said multi-tiered pickup cavity 106.

Said plug 4704 of said last plug plate set 4700x comprises said mounting bracket 1704 for said guitar pickup 1700.

Said workpiece 1800 comprises said guitar body 108 of said guitar 302.

Said cavity routing tool assembly 100 further comprises said index system 3400. Said index system 3400 comprises said top index plate 3402, and said index key assembly 3406 having said first index key 3406a and said second index key 3406b. Said index system 3400 and said two or more plug-plate sets 4700 selectively interact to align said plurality of plates 102 with one another. Said plate 4702 of said first plug-plate set 4700a can be also referred to as said bottom index plate 3404 of said index system 3400. Said index system 3400 can be configured to align said top index plate 3402 with said bottom index plate 3404 through said pilot aperture 3800 in said workpiece 1800 by installing said first index key 3406a into said second index key 3406b through said pilot aperture 3800, and aligning and securing said routing cavity 202 of said top index plate 3402 with said plug portion 4800 of said first index key 3406a. Regarding an interaction between said index system 3400 and said first plug-plate set 4700a, said plate 4702 of said first plug-plate set 4700a can be configured to align and secure to said plug portion 4800 of said second index key 3406b by sliding said routing cavity 202 of said plate 4702 around said plug portion 4800 of said second index key 3406b, having aligned said top index plate 3402 with said plate 4702 of said first plug-plate set 4700a, said index key assembly 3406 can be configured to be removed from 1800, said routing cavity 202 of said top index plate 3402 can be configured to guide a top router cut in said workpiece 1800, and said routing cavity 202 of said plate 4702 of said first plug-plate set 4700a can be configured to guide a bottom router cut in said workpiece 1800. Remaining sets among said two or more plug-plate sets 4700 can be configured to further cut said multi-tiered pickup cavity 106 into said workpiece 1800 in relationship to one another.

Said cavity routing tool assembly 100 for aligning said plurality of plates 102 with one another in a preconfigured manner using said plurality of plugs 104 to cut said multi-tiered pickup cavity 106 into said workpiece 1800. Said cavity routing tool assembly 100 comprises said index system 3400 and said two or more plug-plate sets 4700. Said cavity routing tool assembly 100 comprises said two or more plug-plate sets 4700, each comprising said plate 4702 and said plug 4704. Said plate 4702 collectively across all said two or more plug-plate sets 4700 can be referred to as said plurality of plates 102, and said plug 4704 can be referred to as said plurality of plugs 104. Said plurality of plugs 104 can be configured to align and guide router cuts to form said multi-tiered pickup cavity 106 in said workpiece 1800. Each among said plurality of plates 102 can be configured to selectively align with portions of said plurality of plugs 104 and ensure said multi-tiered pickup cavity 106 can be correctly formed in said workpiece 1800. Each among said plurality of plates 102 comprises said plate body 200, and said routing cavity 202. Each among said plurality of plugs 104 comprises said lower plug portion 208 and said upper plug portion 210. Said index system 3400 comprises said top index plate 3402, and said index key assembly 3406 having said first index key 3406a and said second index key 3406b. Said index system 3400 and said two or more plug-plate sets 4700 selectively interact to align said plurality of plates 102 with one another. Said plate 4702 of said first plug-plate set 4700a can be also referred to as said bottom index plate 3404 of said index system 3400. Said index system 3400 can be configured to align said top index plate 3402 with said bottom index plate 3404 through said pilot aperture 3800 in said workpiece 1800 by installing said first index key 3406a into said second index key 3406b through said pilot aperture 3800, and aligning and securing said routing cavity 202 of said top index plate 3402 with said plug portion 4800 of said first index key 3406a. Regarding an interaction between said index system 3400 and said first plug-plate set 4700a, said plate 4702 of said first plug-plate set 4700a can be configured to align and secure to said plug portion 4800 of said second index key 3406b by sliding said routing cavity 202 of said plate 4702 around said plug portion 4800 of said second index key 3406b, having aligned said top index plate 3402 with said plate 4702 of said first plug-plate set 4700a, said index key assembly 3406 can be configured to be removed from 1800, said routing cavity 202 of said top index plate 3402 can be configured to guide a top router cut in said workpiece 1800, and said routing cavity 202 of said plate 4702 of said first plug-plate set 4700a can be configured to guide a bottom router cut in said workpiece 1800. Said two or more plug-plate sets 4700 can be referred to using said set integer 4706 comprising an identifier for each set, wherein said first plug-plate set 4700a comprises a first among said two or more plug-plate sets 4700 wherein said set integer 4706 equals one, and said last plug plate set 4700x comprises a last among said two or more plug-plate sets 4700 where said set integer 4706 can be the highest value within said two or more plug-plate sets 4700. Each among said two or more plug-plate sets 4700 can be designed in relationship to one another. Regarding said two or more plug-plate sets 4700, a current set and a next set comprise plug plate sets having sequential counts of said set integer 4706. Said two or more plug-plate sets 4700 each comprise said plate 4702 and said plug 4704. Regarding said current set, said routing cavity 202 of said plate 4702 can be configured to selectively attach to a portion of said workpiece 1800 and align a current cut among said multi-tiered pickup cavity 106 into said workpiece 1800, said plate 4702 can be configured to be removed from said workpiece 1800, and said upper plug portion 210 of said plug 4704 of said current set can be configured to align and fit into said current cut. Regarding the interaction of said current set with said next set, said lower plug portion 208 of said plug 4704 in said current set can be configured to align with and fit within said routing cavity 202 of said plate 4702 of said next set. Said two or more plug-plate sets 4700 can be configured in the relationships described as said current set and said next set from said first plug-plate set 4700a to said last plug plate set 4700x. Said current cut for said first plug-plate set 4700a comprise said cutting location 600 in said workpiece 1800. Said multi-tiered pickup cavity 106 comprises the sum of each said current cut in said workpiece 1800 for each among said plurality of plates 102 in said two or more plug-plate sets 4700. Said two or more plug-plate sets 4700 can be configured to align each said routing cavity 202 among said plurality of plates 102 using said plurality of plugs 104.

Said upper portion horizontal cross-section 212 of said upper plug portion 210 of said plug 4704 can match said router cavity horizontal cross-section 214 of said routing cavity 202 of said plate 4702.

For each among said two or more plug-plate sets 4700, said lower plug portion 208 comprises a larger perimeter than said upper plug portion 210 of said plate 4702.

Said multi-tiered pickup cavity 106 comprises a cumulative cavity by cuts made using said plate 4702 in said first plug-plate set 4700a, said second plug-plate set 4700b and said third plug-plate set 4700c. Said plug 4704 of said third plug-plate set 4700c comprises said mounting bracket 1704 for mounting said guitar pickup 1700 int said workpiece 1800 within said multi-tiered pickup cavity 106.

1. A cavity routing tool assembly for aligning a plurality of plates with one another in a preconfigured manner using a plurality of plugs to cut a multi-tiered pickup cavity into a workpiece, wherein:
said cavity routing tool assembly comprises two or more plug-plate sets, each comprising a plate and a plug;
said plate collectively across all said two or more plug-plate sets are referred to as said plurality of plates, and said plug are referred to as said plurality of plugs;
said plurality of plugs are configured to align and guide router cuts to form said multi-tiered pickup cavity in said workpiece;
each among said plurality of plates are configured to selectively align with portions of said plurality of plugs and ensure said multi-tiered pickup cavity is correctly formed in said workpiece;
each among said plurality of plates comprises a plate body, and a routing cavity;
each among said plurality of plugs comprises a lower plug portion and an upper plug portion;
said two or more plug-plate sets are referred to using a set integer comprising an identifier for each set, wherein
A first plug-plate set comprises a first among said two or more plug-plate sets wherein said set integer equals one, and
a last plug plate set comprises a last among said two or more plug-plate sets where said set integer is the highest value within said two or more plug-plate sets;
each among said two or more plug-plate sets are designed in relationship to one another;
regarding said two or more plug-plate sets, a current set and a next set comprise plug plate sets having sequential counts of said set integer;
said two or more plug-plate sets each comprise said plate and said plug;
regarding said current set,
said routing cavity of said plate is configured to selectively attach to a portion of said workpiece and align a current cut among said multi-tiered pickup cavity into said workpiece,
said plate is configured to be removed from said workpiece, and
said upper plug portion of said plug of said current set is configured to align and fit into said current cut;
regarding the interaction of said current set with said next set,
said lower plug portion of said plug in said current set is configured to align with and fit within said routing cavity of said plate of said next set;
said two or more plug-plate sets are configured in the relationships described as said current set and said next set from said first plug-plate set to said last plug plate set;
said current cut for said first plug-plate set comprise a cutting location in said workpiece;
said multi-tiered pickup cavity comprises the sum of each said current cut in said workpiece for each among said plurality of plates in said two or more plug-plate sets;
said two or more plug-plate sets are configured to align each said routing cavity among said plurality of plates using said plurality of plugs;
One or more alignment markings are displayed in an exterior surface of said plurality of plates;
Said upper plug portion of said plurality of plugs are smaller than said lower plug portion of said plurality of plugs;
Said set integer for said last plug plate set comprises three;
said two or more plug-plate sets comprises said first plug-plate set, a second plug-plate set and a third plug-plate set; and
said third plug-plate set comprises said last plug plate set.

2. A cavity routing tool assembly for aligning a plurality of plates with one another in a preconfigured manner using a plurality of plugs to cut a multi-tiered pickup cavity into a workpiece, wherein:
said cavity routing tool assembly comprises two or more plug-plate sets, each comprising a plate and a plug;
said plate collectively across all said two or more plug-plate sets are referred to as said plurality of plates, and said plug are referred to as said plurality of plugs;
said plurality of plugs are configured to align and guide router cuts to form said multi-tiered pickup cavity in said workpiece;
each among said plurality of plates are configured to selectively align with portions of said plurality of plugs and ensure said multi-tiered pickup cavity is correctly formed in said workpiece;
each among said plurality of plates comprises a plate body, and a routing cavity;
each among said plurality of plugs comprises a lower plug portion and an upper plug portion;
said two or more plug-plate sets are referred to using a set integer comprising an identifier for each set, wherein
A first plug-plate set comprises a first among said two or more plug-plate sets wherein said set integer equals one, and
a last plug plate set comprises a last among said two or more plug-plate sets where said set integer is the highest value within said two or more plug-plate sets;
each among said two or more plug-plate sets are designed in relationship to one another;
regarding said two or more plug-plate sets, a current set and a next set comprise plug plate sets having sequential counts of said set integer;
said two or more plug-plate sets each comprise said plate and said plug;
regarding said current set,
said routing cavity of said plate is configured to selectively attach to a portion of said workpiece and align a current cut among said multi-tiered pickup cavity into said workpiece,
said plate is configured to be removed from said workpiece, and
said upper plug portion of said plug of said current set is configured to align and fit into said current cut;
regarding the interaction of said current set with said next set,
said lower plug portion of said plug in said current set is configured to align with and fit within said routing cavity of said plate of said next set;
said two or more plug-plate sets are configured in the relationships described as said current set and said next set from said first plug-plate set to said last plug plate set;
said current cut for said first plug-plate set comprise a cutting location in said workpiece;
said multi-tiered pickup cavity comprises the sum of each said current cut in said workpiece for each among said plurality of plates in said two or more plug-plate sets; and
said two or more plug-plate sets are configured to align each said routing cavity among said plurality of plates using said plurality of plugs.

3. The cavity routing tool assembly of claim 2, wherein:
each among said plurality of plates comprises one or more alignment markings;
said one or more alignment markings comprises a first alignment marking and a second alignment marking; and
said first alignment marking and said second alignment marking are perpendicular.

4. The cavity routing tool assembly of claim 3, wherein:
said one or more alignment markings are displayed in an exterior surface of said plurality of plates.

5. The cavity routing tool assembly of claim 2, wherein:
said upper plug portion of said plurality of plugs are smaller than said lower plug portion of said plurality of plugs.

6. The cavity routing tool assembly of claim 2, wherein:
an upper portion horizontal cross-section of said upper plug portion of said plug can match a router cavity horizontal cross-section of said routing cavity of said plate.

7. The cavity routing tool assembly of claim 2, wherein:
said cavity routing tool assembly is configured to align with each said routing cavity of said plurality of plates using said plurality of plugs by:
inserting a portion of said upper plug portion into a portion of said multi-tiered pickup cavity, and
inserting a portion of said lower plug portion into another among said plurality of plates.

8. The cavity routing tool assembly of claim 2, wherein:
for each among said two or more plug-plate sets,
said lower plug portion comprises a larger perimeter than said upper plug portion of said plate.

9. The cavity routing tool assembly of claim 2, wherein:
said set integer for said last plug plate set comprises three;
said two or more plug-plate sets comprises said first plug-plate set, a second plug-plate set and a third plug-plate set; and
said third plug-plate set comprises said last plug plate set.

10. The cavity routing tool assembly of claim 9, wherein:
said multi-tiered pickup cavity comprises a cumulative cavity by cuts made using said plate in said first plug-plate set, said second plug-plate set and said third plug-plate set; and
said plug of said third plug-plate set comprises a mounting bracket for mounting a guitar pickup int said workpiece within said multi-tiered pickup cavity.

11. The cavity routing tool assembly of claim 2, wherein:
said plug of said last plug plate set comprises said mounting bracket for said guitar pickup.

12. The cavity routing tool assembly of claim 2, wherein:
said workpiece comprises a guitar body of a guitar.

13. The cavity routing tool assembly of claim 2, wherein:
said cavity routing tool assembly further comprises an index system;
said index system comprises a top index plate, and an index key assembly having a first index key and a second index key;
Said index system and said two or more plug-plate sets selectively interact to align said plurality of plates with one another;
said plate of said first plug-plate set is also referred to as a bottom index plate of said index system;
said index system is configured to align said top index plate with said bottom index plate through a pilot aperture in said workpiece by
installing said first index key into said second index key through said pilot aperture, and
aligning and securing said routing cavity of said top index plate with a plug portion of said first index key;
regarding an interaction between said index system and said first plug-plate set,
said plate of said first plug-plate set is configured to align and secure to said plug portion of said second index key by sliding said routing cavity of said plate around said plug portion of said second index key,
having aligned said top index plate with said plate of said first plug-plate set, said index key assembly is configured to be removed from said workpiece,
said routing cavity of said top index plate is configured to guide a top router cut in said workpiece, and
said routing cavity of said plate of said first plug-plate set is configured to guide a bottom router cut in said workpiece; and
remaining sets among said two or more plug-plate sets are configured to further cut said multi-tiered pickup cavity into said workpiece in relationship to one another.

14. A cavity routing tool assembly for aligning a plurality of plates with one another in a preconfigured manner using a plurality of plugs to cut a multi-tiered pickup cavity into a workpiece, wherein:
said cavity routing tool assembly comprises an index system and two or more plug-plate sets;
said cavity routing tool assembly comprises said two or more plug-plate sets, each comprising a plate and a plug;
said plate collectively across all said two or more plug-plate sets are referred to as said plurality of plates, and said plug are referred to as said plurality of plugs;
said plurality of plugs are configured to align and guide router cuts to form said multi-tiered pickup cavity in said workpiece;
each among said plurality of plates are configured to selectively align with portions of said plurality of plugs and ensure said multi-tiered pickup cavity is correctly formed in said workpiece;
each among said plurality of plates comprises a plate body, and a routing cavity;
each among said plurality of plugs comprises a lower plug portion and an upper plug portion;
said index system comprises a top index plate, and an index key assembly having a first index key and a second index key;
Said index system and said two or more plug-plate sets selectively interact to align said plurality of plates with one another;
said plate of a first plug-plate set is also referred to as a bottom index plate of said index system;
said index system is configured to align said top index plate with said bottom index plate through a pilot aperture in said workpiece by
installing said first index key into said second index key through said pilot aperture, and
aligning and securing said routing cavity of said top index plate with a plug portion of said first index key;
regarding an interaction between said index system and said first plug-plate set,
said plate of said first plug-plate set is configured to align and secure to said plug portion of said second index key by sliding said routing cavity of said plate around said plug portion of said second index key,
having aligned said top index plate with said plate of said first plug-plate set, said index key assembly is configured to be removed from said workpiece,
said routing cavity of said top index plate is configured to guide a top router cut in said workpiece, and
said routing cavity of said plate of said first plug-plate set is configured to guide a bottom router cut in said workpiece;
said two or more plug-plate sets are referred to using a set integer comprising an identifier for each set, wherein
Said first plug-plate set comprises a first among said two or more plug-plate sets wherein said set integer equals one, and
a last plug plate set comprises a last among said two or more plug-plate sets where said set integer is the highest value within said two or more plug-plate sets;
each among said two or more plug-plate sets are designed in relationship to one another;
regarding said two or more plug-plate sets, a current set and a next set comprise plug plate sets having sequential counts of said set integer;
said two or more plug-plate sets each comprise said plate and said plug;
regarding said current set,
said routing cavity of said plate is configured to selectively attach to a portion of said workpiece and align a current cut among said multi-tiered pickup cavity into said workpiece,
said plate is configured to be removed from said workpiece, and
said upper plug portion of said plug of said current set is configured to align and fit into said current cut;
regarding the interaction of said current set with said next set,
said lower plug portion of said plug in said current set is configured to align with and fit within said routing cavity of said plate of said next set;
said two or more plug-plate sets are configured in the relationships described as said current set and said next set from said first plug-plate set to said last plug plate set;
said current cut for said first plug-plate set comprise a cutting location in said workpiece;
said multi-tiered pickup cavity comprises the sum of each said current cut in said workpiece for each among said plurality of plates in said two or more plug-plate sets; and
said two or more plug-plate sets are configured to align each said routing cavity among said plurality of plates using said plurality of plugs.

15. The cavity routing tool assembly of claim 14, wherein:
an upper portion horizontal cross-section of said upper plug portion of said plug can match a router cavity horizontal cross-section of said routing cavity of said plate.

16. The cavity routing tool assembly of claim 14, wherein:
for each among said two or more plug-plate sets,
said lower plug portion comprises a larger perimeter than said upper plug portion of said plate.

17. The cavity routing tool assembly of claim 16, wherein:
said multi-tiered pickup cavity comprises a cumulative cavity by cuts made using said plate in said first plug-plate set, a second plug-plate set and a third plug-plate set; and
said plug of said third plug-plate set comprises a mounting bracket for mounting a guitar pickup int said workpiece within said multi-tiered pickup cavity.

18. The cavity routing tool assembly of claim 14, wherein:
said plug of said last plug plate set comprises said mounting bracket for said guitar pickup.
